(19) United States
(12) Patent Application Publication
(10) Pub. No.: US 2008/0113121 A1
(43) Pub. Date: May 15, 2008

(54) Cyclic polyolefin film, and polarizing plate and liquid crystal display device using the same

(75) Inventor: Ryosuke Takada, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/979,722

(22) Filed: Nov. 7, 2007

(30) Foreign Application Priority Data
Nov. 13, 2006 (JP) 2006-307005
Apr. 27, 2007 (JP) 2007-119851

(51) Int. Cl. G02B 5/30; B32B 9/04; C08L 71/00; C09K 19/02

(52) U.S. Cl. 428/1.31; 428/411.1; 524/315; 524/81

(57) ABSTRACT

A cyclic polyolefin film includes a cyclic polyolefin; and a compound having a structure represented by the following formula (I) or (II):

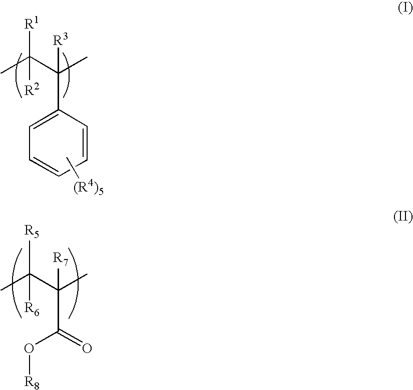

wherein R¹ to R⁸ each independently represents a hydrogen atom; a halogen atom; a substituted or unsubstituted hydrocarbon group that has a carbon number of 1 to 30 and that may have a linking group containing an oxygen atom, a sulfur atom, a nitrogen atom or a silicon atom; or a polar group, and R⁴s may be all the same atom or group, may be individually different atoms or groups or may combine with each other to form a carbon ring or a hetero ring, in which the carbon ring and the hetero ring may be in a monocyclic structure or may form a polycyclic structure through condensation by another ring.

### BACKGROUND OF THE INVENTION

1. Field of the Invention

The present invention relates to a cyclic polyolefin film, and a polarizing plate and a liquid crystal display device each using the same.

2. Description of the Related Art

A polarizing plate is usually produced by laminating a protective film mainly comprising a cellulose triacetate on both sides of a polarizing film obtained by orienting and adsorbing iodine or a dichroic dye to polyvinyl alcohol. The cellulose triacetate is being widely used as the protective film for polarizing plates because of its characteristic features such as toughness, flame retardancy and high optical isotropy (retardation value is low). A liquid crystal display device comprises a polarizing plate, a liquid crystal cell and the like. However, the cellulose triacetate film allows for absorption or permeation of moisture in a large amount and this gives rise to a problem that the optically compensating performance changes or the polarizer readily deteriorates.

A cyclic polyolefin film is attracting attention as a film capable of improving the moisture absorption or permeation of cellulose triacetate film, and development of a polarizing plate protective film by a heat-melt film-forming or solution film-forming method is proceeding. The cyclic polyolefin film expresses high optical properties and less changes the optical properties due to change in the temperature or humidity, and development as a phase difference film (sometimes called a retardation film) is being made (JP-A-2003-212927 (the term “JP-A” as used herein means an “unexamined published Japanese patent application”), JP-A-2004-126026, JP-A-2002-114827, and WO 2004/049011).

### SUMMARY OF THE INVENTION

However, since the cyclic polyolefin film expresses high optical properties, Re(λ) or Rth(λ) is greatly changed by a slight difference in the stretch ratio and there is a problem that subtle adjustment of optical properties is difficult or optical properties satisfying both Re(λ) and Rth(λ) as intended can be hardly obtained only by the stretching process.

In brief, as for the conventionally proposed cyclic polyolefin film, there is demanded to develop a cyclic polyolefin film with Re(λ) and Rth(λ) completely controlled as intended while maintaining the properties heretofore required, such as low moisture absorption or permeation and less change in the optical properties due to temperature or humidity change.

An object of the present invention is to provide a cyclic polyolefin film assured of low moisture absorption or permeation, small change in the optical properties due to temperature or humidity change, less optical unevenness, and optical properties enabling individual control of Rth(λ) and Re(λ). Another object of the present invention is to provide a polarizing plate and a liquid crystal display device, which are excellent in the film-forming stability and processing characteristics and free of image unevenness.

As a result of intensive studies, the present inventors have succeeded in reducing the retardation Rth in the thickness direction and obtaining intended optical properties at the film formation by incorporating a cyclic polyolefin-based resin and at least one polymer compound having a Rth-decreasing effect. Furthermore, a cyclic polyolefin film having Re and Rth each independently controlled as desired can be obtained by stretching the film.

That is, the present invention comprises the following constructions.

<1> A cyclic polyolefin film comprising:

a cyclic polyolefin; and

a compound having a structure represented by the following formula (I) or (II):

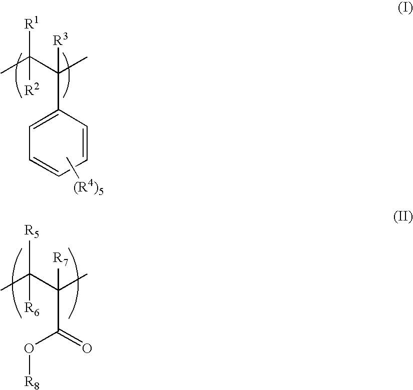

wherein

R¹ to R⁸ each independently represents a hydrogen atom; a halogen atom; a substituted or unsubstituted hydrocarbon group that has a carbon number of 1 to 30 and that may have a linking group containing an oxygen atom, a sulfur atom, a nitrogen atom or a silicon atom; or a polar group, and

R⁴s may be all the same atom or group, may be individually different atoms or groups or may combine with each other to form a carbon ring or a hetero ring, in which the carbon ring and the hetero ring may be in a monocyclic structure or may form a polycyclic structure through condensation by another ring.

<2> The cyclic polyolefin film as described in <1>, which satisfies the following mathematical formula (1):

|σ(A)−σ(P)|<4 Mathematical formula (1):

wherein

|σ(A)−σ(P)| is the absolute value of σ(A)−σ(P),

σ(A) is a solubility parameter (SP value) (unit: MPa^{1/2}) of the compound having a structure represented by formula (I) or (II), and

σ(P) is the solubility parameter (SP value) (unit: MPa^{1/2}) of the cyclic polyolefin.

<3> The cyclic polyolefin film as described in <1>, which satisfies the following mathematical formulae (2) and (3):

Rth(A)−Rth(0)≦−10 Mathematical formula (2):

(Rth(A)−Rth(0))/A≦−1.0 Mathematical formula (3):

wherein,

Rth(A) represents Rth (unit: nm) as converted to film thickness of 80 μm, of the film containing the compound having a structure represented by formula (I) or (II) in an amount of A% based on the mass of said cyclic polyolefin,

Rth(0) represents Rth (unit: nm) as converted to film thickness of 80 μm, of the film not containing the compound having a structure represented by formula (I) or (II), and

A represents a mass (unit: %) of the compound having a structure represented by formula (I) or (II) based on the mass of said cyclic polyolefin.

<4> The cyclic polyolefin film as described in <1>, wherein

the compound having a structure represented by formula (I) or (II) has a weight average molecular weight of from 500 to 300,000.

<5> The cyclic polyolefin film as described in <1>, wherein

the compound having a structure represented by formula (I) or (II) is contained in an amount of 0.1 to 40 mass % based on the cyclic polyolefin.

<6> The cyclic polyolefin film as described in <1>, which is a stretched cyclic polyolefin.

<7> The cyclic polyolefin film as described in <1>, which has a thickness of from 20 to 200 μm.

<8> A polarizing plate comprising:

a polarizer; and

a pair of protective films, between which the polarizer is sandwiched,

wherein at least one of the protective films is the cyclic polyolefin film as described in <1>.

<9> A liquid crystal display device comprising

a liquid crystal cell; and

a pair of polarizing plates, between which the liquid crystal display is sandwiched, wherein at least one of the polarizing plates is the polarizing plate as described in <8>.

### DETAILED DESCRIPTION OF THE INVENTION

The present invention is described in detail below.

Incidentally, the expression “(numerical value 1) to (numerical value 2)” or “from (numerical value 1) to (numerical value 2)” as used in the present invention means “(numerical value 1) or more and (numerical value 2) or less”.

The materials and production method of the cyclic polyolefin film of the present invention, and the cyclic polyolefin film obtained are described below.

The cyclic polyolefin film of the present invention is produced to contain at least a cyclic polyolefin.

### (Cyclic Polyolefin)

In the present invention, the “cyclic polyolefin-based resin” indicates a polymer resin having a cyclic polyolefin structure. In the present invention, unless otherwise indicated, the term simply referred to as a “cyclic polyolefin” indicates a “cyclic polyolefin-based resin” and includes “cyclic olefin-based resin” (that is, a “cyclic olefin-based resin” is sometimes called a “cyclic polyolefin”).

Examples of the polymer resin having a cyclic olefin structure for use in the present invention include:

(1) a norbornene-based polymer,

(2) a monocyclic olefin polymer,

(3) a cyclic conjugated diene polymer,

(4) a vinyl alicyclic hydrocarbon polymer, and hydrides of (1) to (4).

The polymer resin which is preferably used in the present invention is an addition (co)polymer cyclic polyolefin containing at least one or more repeating units represented by the following formula (4), or an addition (co)polymer cyclic polyolefin further containing, if desired, at least one or more repeating units represented by formula (3). A ring-opened (co)polymer containing at least one cyclic repeating unit represented by formula (5) may also be suitably used.

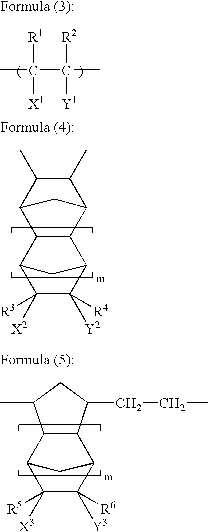

In the formulae, m represents an integer of 0 to 4, R¹ to R⁶ each independently represents a hydrogen atom or a hydrocarbon group having a carbon number of 1 to 10, and X¹ to X³ and Y¹ to Y³ each independently represents a hydrogen atom, a hydrocarbon group having a carbon number of 1 to 10, a halogen atom, a halogen atom-substituted hydrocarbon group having a carbon number of 1 to 10, —(CH₂)ₙCOOR¹¹, —(CH₂)ₙOCOR¹², —(CH₂)ₙNCO, —(CH₂)ₙNO₂, —(CH₂)ₙCN, —(CH₂)ₙCONR¹³R¹⁴, —(CH₂)ₙNR¹³R¹⁴, —(CH₂)ₙOZ or —(CH₂)ₙW or represents (—CO)₂O or (—CO)₂NR¹⁵ constituted by X¹ and Y¹, X² and Y², or X³ and Y³. Here, R¹¹, R¹², R¹³, R¹⁴ and R¹⁵ each independently represents a hydrogen atom or a hydrocarbon group having a carbon number of 1 to 20, Z represents a hydrocarbon group or a halogen-substituted hydrocarbon group, W represents SiR¹⁶ₚD₃₋ₚ (R¹⁶ represents a hydrocarbon group having a carbon number of 1 to 10, D represents a halogen atom, —OCOR¹⁶ or —OR¹⁶, and p represents an integer of 0 to 3), and n represents an integer of 0 to 10.

By introducing a functional group having high polarity into the substituents X¹ to X³ and Y¹ to Y³, the retardation (Rth) in the thickness direction of the optical film can be made large and the developability of in-plane retardation (Re) can be elevated. When the film has high Re developability, the Re value can be made large by stretching the film in the film-forming process.

As for the norbornene-based addition (co)polymer, those described, for example, in JP-A-10-7732, JP-T-2002-504184 (the term “JP-T” as used herein means a “published Japanese translation of a PCT patent application”), U.S. Patent Application 2004229157A1 and International Publication 2004/070463A1, pamphlet, may be used. This (co)polymer can be obtained by addition-polymerizing norbornene-based polycyclic unsaturated compounds with each other. If desired, a norbornene-based polycyclic unsaturated compound may be addition-polymerized with a conjugated diene such as ethylene, propylene, butene, butadiene and isoprene; a non-conjugated diene such as ethylidene norbornene; or a linear diene compound such as acrylonitrile, acrylic acid, methacrylic acid, maleic anhydride, acrylic acid ester, methacrylic acid ester, maleimide, vinyl acetate and vinyl chloride. As for this norbornene-based addition (co)polymer, a commercially available product may also be used. Specific examples thereof include those available under the trade name of APL from Mitsubishi Chemical Corp., including grades differing in the glass transition temperatures (Tg), such as APL8008T (Tg: 70° C.), APL6013T (Tg: 125° C.) and APL6015T (Tg: 145° C.). Also, a pellet such as TOPAS8007, TOPAS6013 and TOPAS6015 is available from Polyplastics Co., Ltd. Furthermore, Appear3000 is available from Ferrania Company.

With respect to the norbornene-based polymer hydride, as disclosed, for example, in JP-A-1-240517, JP-A-7-196736, JP-A-60-26024, JP-A-62-19801, JP-A-2003-1159767 and JP-A-2004-309979, those prepared by subjecting a polycyclic unsaturated compound to addition polymerization or ring-opening metathesis polymerization and then to hydrogenation may be used. In the norbornene-based polymer for use in the present invention, R⁵ and R⁶ each is preferably a hydrogen atom or —CH₃, X³ and Y³ each is preferably a hydrogen atom, Cl or —COOCH₃. Other groups are appropriately selected. As for this norbornene-based resin, a commercially available product may also be used. Specific examples thereof include those available under the trade name of Arton G or Arton F from JSR Corp. or under the trade name of Zeonor ZF14, ZF16, Zeonex 250 or Zeonex 280 from ZEON Corp., and these products can be used.

The weight average molecular weight (Mw) as measured by gel permeation chromatography (GPC, developing solvent: tetrahydrofuran, polystyrene conversion method) of the cyclic polyolefin-based resin for use in the present invention is preferably from 5,000 to 1,000,000, more preferably from 10,000 to 500,000, still more preferably from 50,000 to 300,000, in terms of polystyrene molecular weight. Also, the molecular weight distribution (Mw/Mn; Mn is a number average molecular weight as measured by GPC) is preferably 10 or less, more preferably 5.0 or less, still more preferably 3.0 or less. The glass transition temperature (Tg; as measured by DSC) is preferably from 50 to 350° C., more preferably from 80 to 330° C., still more preferably from 100 to 300° C.

### [Compound Having Structure Represented by Formula (I) or (II)]

The cyclic polyolefin film of the present invention contains at least one kind of the compound having a structure represented by formula (I) or (II).

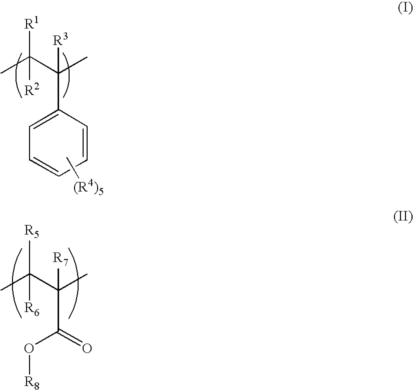

In the formulae, R¹ to R⁸ each independently represents a hydrogen atom; a halogen atom; a substituted or unsubstituted hydrocarbon group having a carbon number of 1 to 30, which may have a linking group containing an oxygen atom, a sulfur atom, a nitrogen atom or a silicon atom; or a polar group. R⁴s may be all the same atom or group, may be individually different atoms or groups or may combine with each other to form a carbon ring or a hetero ring (the carbon ring or hetero ring may be in a monocyclic structure or may form a polycyclic structure through condensation by another ring).

Formula (I) is a structural unit obtained from an aromatic vinyl-based monomer. Specific examples of the aromatic vinyl-based monomer include styrene: alkyl-substituted styrenes such as α-methylstyrene, β-methylstyrene and p-methylstyrene; halogen-substituted styrenes such as 4-chlorostyrene and 4-bromostyrene; hydroxystyrenes such as p-hydroxystyrene, α-methyl-p-hydroxystyrene, 2-methyl-4-hydroxystyrene and 3,4-dihydroxystyrene; vinyl benzyl alcohols; alkoxy-substituted styrenes such as p-methoxystyrene, p-tert-butoxystyrene and m-tert-butoxystyrene; vinylbenzoic acids such as 3-vinylbenzoic acid and 4-vinylbenzoic acid; vinylbenzoic acid esters such as methyl-4-vinyl benzoate and ethyl-4-vinyl benzoate; 4-vinylbenzyl acetate; 4-acetoxystyrene; amidostyrenes such 2-butylamidostyrene, 4-methylamidostyrene and p-sulfonamidostyrene; aminostyrenes such as 3-aminostyrene, 4-aminostyrene, 2-isopropenylaniline and vinylbenzyldimethylamine; nitrostyrenes such as 3-nitrostyrene and 4-nitrostyrene; cyanostyrenes such as 3-cyanostyrene and 4-cyanostyrene; vinylphenylacetonitrile; arylstyrenes such as phenylstyrene; and indenes, but the present invention is not limited to these specific examples. Two or more kinds of these monomers may be used as the copolymerization component. Among these, styrene and α-methylstyrene are preferred because these are easily available in industry and are inexpensive.

Formula (II) is a structural unit obtained from an acrylic acid ester-based monomer. Examples of the acrylic acid ester-based monomer include methyl acrylate, ethyl acrylate, (i- or n-)propyl acrylate, (n-, i-, s- or t-)butyl acrylate, (n-, i- or s-)pentyl acrylate, (n- or i-)hexyl acrylate, (n- or i-)heptyl acrylate, (n- or i-)octyl acrylate, (n- or i-)nonyl acrylate, (n- or i-)myristyl acrylate), (2-ethylhexyl) acrylate, (ε-caprolactone)acrylate, (2-hydroxyethyl)acrylate, (2-hydroxypropyl)acrylate, (3-hydroxypropyl)acrylate, (4-hydroxybutyl)acrylate, (2-hydroxybutyl)acrylate, (2-methoxyethyl)acrylate, (2-ethoxyethyl)acrylate, phenyl acrylate, phenyl methacrylate, (2- or 4-chlorophenyl)acrylate, (2- or 4-chlorophenyl)methacrylate, (2-, 3- or 4-ethoxycarbonylphenyl)acrylate, (2-, 3- or 4-ethoxycarbonylphenyl)methacrylate, (o-, m- or p-tolyl)acrylate), (o-, m- or p-tolyl)methacrylate, benzyl acrylate, benzyl methacrylate, phenethyl acrylate, phenethyl methacrylate, (2-naphthyl)acrylate, cyclohexyl acrylate, cyclohexyl methacrylate, (4-methylcyclohexyl)acrylate, (4-methylcyclohexyl)methacrylate, (4-ethylcyclohexyl)acrylate, (4-ethylcyclohexyl)methacrylate, and those obtained by converting the acrylic acid esters above into a methacrylic acid ester, but the present invention is not limited to these specific examples. Two or more kinds of these monomers may be used as the copolymerization component. Among these, methyl acrylate, ethyl acrylate, (i- or n-)propyl acrylate, (n-, i-, s- or t-)butyl acrylate, (n-, i- or s-)pentyl acrylate, (n- or i-)hexyl acrylate, and those obtained by converting these acrylic acid esters into a methacrylic acid ester are preferred, because these are easily available in industry and are inexpensive.

The above-described (co) polymer preferably contains at least one structural unit obtained from the aromatic vinyl-based monomer represented by formula (I) or the acrylic acid ester-based monomer represented by formula (II). As for the other structures constituting the copolymerization composition, those having good copolymerizability with the monomer above are preferred, and examples thereof include an acid anhydride such as maleic anhydride, citraconic anhydride, cis-1-cyclohexene-1,2-dicarboxylic anhydride, 3-methyl-cis-1-cyclohexene-1,2-dicarboxylic anhydride, 4-methyl-cis-1-cyclohexene-1,2-dicarboxylic anhydride; a nitrile group-containing radical polymerizable monomer such as acrylonitrile and methacrylonitrile; an amide bond-containing radical polymerizable monomer such as acrylamide, methacrylamide and trifluoromethanesulfonylaminoethyl (meth)acrylate; fatty acid vinyls such as vinyl acetate; a chlorine-containing radical polymerizable monomer such as vinyl chloride and vinylidene chloride; and conjugated diolefins such as 1,3-butadiene, isoprene and 1,4-dimethylbutadiene, but the present invention is not limited thereto.

In the case of using the copolymer above, the copolymer composition preferably contains at least 30 mol % of the group represented by formula (I) and preferably contains at least 20 mol % or more of the group represented by formula (II). The proportion of other copolymerization components is preferably 50 mol % or less.

Out of the structures represented by formulae (I) and (II), for obtaining good transparency after mixing with the cyclic olefin polymer and film formation, it is important that the compound has good compatibility. The compatibility of the polymer can be estimated by the solubility parameter (SP value), and the relationship between the SP value of the cyclic polyolefin and the SP value of the structure represented by formula (I) or (II) preferably satisfies the following mathematical formula (1):

|σ(A)−σ(P)|<4 Mathematical formula (1):

In mathematical formula (1), |σ(A)−σ(P)| is the absolute value of σ(A)−σ(P).

σ(A) is the solubility parameter (SP value) (MPa^{1/2}) of the compound having a structure represented by formula (I) or (II).

σ(P) is the solubility parameter (SP value) (MPa^{1/2}) of the cyclic polyolefin.

In order to enhance the compatibility with the cyclic olefin polymer and enlarge the compatible region in terms of the amount added and molecular weight,

|σ(A)−σ(P)|<3 Mathematical formula (1-2):

is preferred,

|σ(A)−σ(P)|<2 Mathematical formula (1-3):

is more preferred, and

|σ(A)−σ(P)|<1 Mathematical formula (1-4):

is most preferred.

The solubility parameter (SP value) is a numerical value defined by the square root of aggregation energy density and denotes an intermolecular force. The SP value is one indication method capable of quantitatively determining the polarity of a polymer and a low-molecular compound such as solvent and can be obtained by calculation according to the following formula or by actual measurement.

SP value (δ)=(ΔEv/V)^{1/2}

In the formula above, ΔEv represents a molar evaporation energy and V represents a molar volume.

Also, ΔEv and V may be the sum (ΔEv) of molar evaporation heats (Δei) and the sum (V) of molar volumes (vi) of atomic groups described in Robert F. Fedors, POLYMER ENGINEERING AND FEBRUARY, Vol. 14, No. 2, pp. 151 and 153 (1974).

By virtue of incorporating at least one compound having a structure represented by formula (I) or (II) into the cyclic polyolefin, the retardation Rth in the thickness direction can be reduced and the intended optical properties can be obtained at the film formation.

In the present invention, reducing Rth of the cyclic polyolefin film means that Rth (nm) in terms of 80-μm thickness of the film containing A % of the compound having a structure represented by formula (I) or (II) is lower by 10 nm or more than Rth (nm) in terms of 80-μm thickness of the film not containing the compound having a structure represented by formula (I) or (II).

In the present invention, the Rth reducing property of the cyclic polyolefin film can be expressed by (Rth(A)−Rth(0))/A.

The cyclic polyolefin film of the present invention preferably satisfies the following mathematical formulae (1) and (2).

Rth(A)−Rth(0)≦−10 Mathematical Formula (1):

In order to obtain desired optical properties,

Rth(A)−Rth(0)≦−30 Mathematical Formula (1-2):

is more preferred, and

Rth(A)−Rth(0)≦−50 Mathematical Formula (1-3):

is most preferred.

(Rth(A)−Rth(0))/A≦−1.0 Mathematical Formula (2):

In order to broaden the control range of optical properties,

(Rth(A)−Rth(0))/A≦−3.0 Mathematical Formula (2-2):

is more preferred, and

(Rth(A)−Rth(0))/A≦−5.0 Mathematical Formula (2-3):

is most preferred.

In mathematical formulae (1), (1-2), (1-3), (2), (2-2) and (2-3),

Rth(A): Rth (nm) in terms of 80 μm thickness of the film containing A % of the structure represented by formula (I) or (II),

Rth(0): Rth (nm) in terms of 80 μm thickness of the film not containing the structure represented by formula (I) or (II), and

A: the mass (%) of the structure represented by formula (I) or (II) based on the mass of the cyclic polyolefin.

The weight average molecular weight of the compound having a structure represented by formula (I) or (II) is preferably from 500 to 300,000 and in order to ensure good compatibility with binder and excellent film transparency after film formation and obtain a film capable of expressing good developability of optical properties, the weight average molecular weight is more preferably from 500 to 15,000, still more preferably from 500 to 5,000.

In the present invention, the weight average molecular weight of the compound incorporated into the cyclic polyolefin is a value measured by GPC (developing solvent: tetrahydrofuran, polystyrene conversion method).

### [Content of Compound Having Structure Represented by Formula (I) or (II)]

The content of the compound having a structure represented by formula (I) or (II) for use in the present invention is preferably from 0.1 to 40 mass % based on the cyclic polyolefin-based resin, and in order to ensure excellent transparency after film formation and obtain a film capable of expressing good developability of optical properties, the content is more preferably from 1 to 30 mass %, still more preferably from 3 to 20 mass %.

One compound having a structure represented by formula (I) or (II) may be used alone, or two or more kinds of these compounds may be mixed at an arbitrary ratio and used.

In the case of using two or more kinds of the compounds having a structure represented by formula (I) or (II), the total content thereof is preferably from 0.1 to 40 mass % based on the cyclic polyolefin-based resin and in order to ensure good transparency after film formation and obtain a film capable of expressing good developability of optical properties, the total content is more preferably from 1 to 30 mass %, still more preferably from 3 to 20 mass %.

### (Method of Adding Compound Having Structure Represented by Formula (I) or (II))

Such a compound may be added at any timing in the process of producing a dope or may be added at the end of the dope preparation step.

### (Fine Particle)

In the present invention, a fine particle is preferably added to the cyclic polyolefin-based resin. By this addition, the film-forming stability and processing suitability of film can be more enhanced and the film can be reduced in the optical unevenness attributable to take-up friction or the like. As for the fine particle usable in the present invention, an organic or inorganic compound fine particle can be used.

Preferred examples of the inorganic compound include a silicon-containing compound, silicon dioxide, titanium oxide, zinc oxide, aluminum oxide, barium oxide, zirconium oxide, strontium oxide, antimony oxide, tin oxide, tin•antimony oxide, calcium oxide, talc, clay, calcined kaolin, calcined calcium silicate, hydrate calcium silicate, aluminum silicate, magnesium silicate and calcium phosphate. A silicon-containing inorganic compound and a metal oxide are more preferred. That is, in the present invention, a metal oxide or an inorganic silicon compound is preferably used as the fine particle. In the present invention, silicon dioxide is more preferably used because the turbidity of film can be reduced. As regards the silicon dioxide fine particle, for example, those commercially available under the trade name such as Aerosil R972, R974, R812, 200, 300, R202, OX50, TT600 (all produced by Nippon Aerosil Co., Ltd.) may be used. As regards the zirconium oxide fine particle, for example, those commercially available under the trade name such as Aerosil R976 and R811 (both produced by Nippon Aerosil Co., Ltd.) may be used.

Examples of the organic compound include polytetrafluoroethylene, cellulose acetate, polystyrene, polymethyl methacrylate, polypropyl methacrylate, polymethyl acrylate, polyethylene carbonate, starch, and a pulverized and classified product thereof. Also, a polymer compound synthesized by the suspension polymerization method, or a polymer compound formed into a spherical shape by the spray dry method, dispersion method or the like, may be used.

The fine particle for use in the present invention is preferably an inorganic compound fine particle or polymer fine particle having an average particle diameter of 0.1 to 3.0 μm, more preferably from 0.15 to 2.0 μm, still more preferably from 0.2 to 1.0 μm.

The average particle diameter of the fine particle as referred to in the present invention means an average aggregate size (average secondary particle diameter) in the case of an aggregating fine particle, and this can be controlled, in terms of the particle size in the liquid dispersion, by the dispersion formulation which is described later. In the case of a non-aggregating fine particle, the average particle diameter means the average value determined by measuring the size of individual particles.

The fine particle for use in the present invention is preferably, in the case of an aggregating fine particle, a fine particle having an average primary particle diameter of 0.05 to 0.5 μm, more preferably from 0.08 to 0.3 μm, still more preferably from 0.1 to 0.25 μm.

The content of the fine particle is, for example, irrespective of whether the fine particle is dispersed in the particle state such as spherical or amorphous particle or dispersed in the molecular state, preferably from 0.0001 to 10 mass %, more preferably from 0.001 to 5 mass %, still more preferably from 0.01 to 3 mass %, based on the entire cyclic polyolefin film.

The light transmittance of the cyclic polyolefin film of the present invention is preferably 88.0% or more, more preferably 89.0% or more, still more preferably 90.0% or more. The transmittance above is a value determined by measuring a sample of 13 mm×40 mm at a measurement wavelength of 550 nm by a spectrophotometer (U-3210, manufactured by Hitachi, Ltd.) at 25° C. and 60% RH.

The method for incorporating the fine particle into the film is not particularly limited, but examples thereof include a film-forming method of casting a solution containing the cyclic polyolefin-based resin and the above-described fine particle, a method of coating a coating solution containing the fine particle on a film obtained by casting the cyclic polyolefin-based resin, and a multilayer casting method. In the present invention, the cyclic polyolefin film is preferably produced by either one of the following two production methods.

1. A production method of a cyclic polyolefin film, comprising a step of dissolving or dispersing the cyclic polyolefin-based resin, the compound having a structure represented by formula (I) or (II), and at least one kind of a fine particle in a solvent, a step of casting the solution or dispersion, a step of drying the film, and a step of taking up the film.

2. A production method of a cyclic polyolefin film, comprising a step of dissolving the cyclic polyolefin-based resin and the compound having a structure represented by formula (I) or (II), a step of casting the solution, a step of drying the film, and a step of taking up the film, wherein the production method comprises a step of coating a coating solution containing at least one kind of a fine particle on at least one surface of the film after casting.

By virtue of producing the film by either one of these two methods, a cyclic polyolefin film suitable as an optical film excellent in the planarity, uniformity and the like can be produced.

In the method of 1 above, the film is formed by casting a solution containing the cyclic polyolefin-based resin and the fine particle. In the case of this method, the fine particle may be dispersed before preparing the cyclic polyolefin solution, or a liquid dispersion of the fine particle may be added immediately before casting the cyclic polyolefin solution. At the preparation of the liquid dispersion, a known method, for example, a normal stirrer, a high-speed stirrer such as homogenizer, media-assisted dispersion such as ball mill, paint shaker and Dyno mill, and ultrasonic disperser, may be used. In the case of dispersing the fine particle in the cyclic polyolefin solution, a surfactant or polymer usually employed as a dispersion aid may be added in a small amount.

In the method of 2 above, the “coating solution” may be sufficient if it mainly comprises the fine particle. A liquid dispersion prepared by merely dispersing the fine particle in an appropriate solvent may be used as the coating solution and coated on the surface of a layer mainly comprising the cyclic polyolefin-based resin (that is, the film after casting). Also, the coating solution may contain a binder, and a layer containing the fine particle may be formed by coating the coating solution.

The coating solution may be coated on one side or both sides of a layer mainly comprising the cyclic polyolefin-based resin.

The binder for the formation of the fine particle layer is not particularly limited and may be a lipophilic binder or a hydrophilic binder. As for the lipophilic binder, a known thermoplastic resin, thermosetting resin, radiation-curable resin or reactive resin, or a mixture thereof may be used. The Tg of the resin is preferably from 80 to 400° C., more preferably from 120 to 350° C., and the weight average molecular weight of the resin is preferably from 10,000 to 1,000,000, more preferably from 10,000 to 500,000. In the case of dispersing the fine particle in the coating solution, the same dispersion method as that in the method of 1 above may be used, and a surfactant or polymer usually employed as a dispersion aid may be added in a small amount.

Examples of the thermoplastic resin include a vinyl-based copolymer such as a vinyl chloride•vinyl acetate copolymer, a copolymer of vinyl chloride and vinyl acetate with vinyl alcohol, maleic acid and/or acrylic acid, a vinyl chloride•vinylidene chloride copolymer, a vinyl chloride•acrylonitrile copolymer and an ethylene•vinyl acetate copolymer; a cellulose derivative such as nitrocellulose, cellulose acetate propionate and cellulose acetate butyrate; a rubber-based resin such as cyclic polyolefin resin, acrylic resin, polyvinyl acetal resin, polyvinyl butyral resin, polyester polyurethane resin, polyether polyurethane resin, polycarbonate polyurethane resin, polyester resin, polyether resin, polyamide resin, amino resin, styrene butadiene resin and butadiene acrylonitrile resin; a silicone-based resin; and a fluorine-based resin.

The thickness of the layer containing the fine particle is preferably from 0.0001 to 10 μm, more preferably from 0.001 to 5 μm, still more preferably from 0.01 to 1 μm.

The production method of a cyclic polyolefin film is described in more detail later.

### (Other Additives)

In the cyclic polyolefin film of the present invention, various additives (for example, deterioration inhibitor, ultraviolet inhibitor, separation accelerator, plasticizer and infrared absorbent) may be added according to usage at each production step of the film. The additive may be a solid matter or an oily matter. That is, the additive is not limited in its melting point or boiling point. For example, ultraviolet absorbing materials having a melting point of 20° C. or less and a melting point of 20° C. or more may be mixed, and deterioration inhibitors may be mixed in the same way. The infrared absorbing dye is described, for example, in JP-A-2001-194522. As for the timing of addition, the additive may be added at any stage in the process of producing the cyclic polyolefin solution (dope), or a step of adding the additive to prepare a dope may be added as a final preparation step in the process of producing the dope. The amount of each material added is not particularly limited as long as its function can be exerted. Also, in the case of forming a multilayer cyclic polyolefin film, the kind or amount added of the additive may differ among the layers.

### (Deterioration Inhibitor)

In the cyclic polyolefin solution for use in the present invention, a known deterioration (oxidation) inhibitor, for example, a phenol-based or hydroquinone-based antioxidant such as 2,6-di-tert-butyl-4-methylphenol, 4,4′-thiobis-(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone and pentaerythrityl-tetrakis[3-(3,5-di-tert-butyl-4-hydroxyphenyl)propionate], may be added. Furthermore, a phosphorus-based antioxidant such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite and bis(2,4-di-tert-butylphenyl)pentaerythritol diphosphite is preferably added. The amount of the antioxidant added is preferably from 0.05 to 5.0 parts by mass per 100 parts by mass of the cyclic polyolefin-based resin.

### (Ultraviolet Absorbent)

In the cyclic polyolefin solution for use in the present invention, an ultraviolet absorbent is preferably used in view of preventing deterioration of a polarizing plate, a liquid crystal and the like. An ultraviolet absorbent having less absorption of visible light at a wavelength of 400 nm or more is preferably used because of its excellent ability of absorbing ultraviolet light at a wavelength of 370 nm or less and giving good liquid crystal display property. Specific examples of the ultraviolet absorbent which is preferably used in the present invention include a hindered phenol-based compound, a hydroxybenzophenone-based compound, a benzotriazole-based compound, a salicylic acid ester-based compound, a benzophenone-based compound, a cyanoacrylate-based compound and a nickel complex salt-based compound. Examples of the hindered phenol-based compound include 2,6-di-tert-butyl-p-cresol, pentaerythrityl-tetrakis[3-(3,5-di-tert-butyl-4-hydroxyphenyl)propionate], N,N′-hexamethylene bis(3,5-di-tert-butyl-4-hydroxy-hydrocinnamide), 1,3,5-trimethyl-2,4,6-tris(3,5-di-tert-butyl-4-hydroxybenzyl)benzene and tris-(3,5-di-tert-butyl-4-hydroxybenzyl)-isocyanurate. Examples of the benzotriazole-based compound include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethylene glycol bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2(2′-hydroxy-3′,5′-di-tert-butylphenol)-5-chlorobenzotriazole, 2(2′-hydroxy-3′,5′-di-tert-amylphenyl)-5-chlorobenzotriazole, 2,6-di-tert-butyl-p-cresol and pentaerythrityl-tetrakis[3-(3,5-di-tert-butyl-4-hydroxyphenyl)propionate]. The amount of the ultraviolet inhibitor added is, in terms of the ratio by mass, preferably from 1 ppm to 1.0%, more preferably from 10 to 1,000 ppm, based on the entire cyclic polyolefin film.

### (Plasticizer)

The cyclic polyolefin-based resin generally has poor flexibility as compared with cellulose acetate and when the film is subjected to flexural stress or shearing stress, cracking or the like is liable to occur in the film. Also, at the processing into an optical film, the cut part is readily cracked to produce chips. The chips produced contaminate the optical film and cause an optical defect. In order to solve such a problem, a plasticizer may be added. Specific examples of the plasticizer include a phthalic acid ester-based compound, a trimellitic acid ester-based compound, an aliphatic dibasic acid ester-based compound, an orthophosphoric acid ester-based compound, an acetic acid ester-based compound, a polyester•epoxidized ester-based compound, a ricinoleic acid ester-based compound, polyolefin-based compound and a polyethylene glycol-based compound.

The plasticizer which can be used is preferably selected from compounds being liquid at ordinary temperature under atmospheric pressure and having a boiling point of 200° C. or more. Specific examples of the compound include the followings.

Examples of the aliphatic dibasic acid ester-based compound include dioctyl adipate (230° C./760 mmHg), dibutyl adipate (145° C./4 mmHg), di-2-ethylhexyl adipate (335° C./760 mmHg), dibutyl diglycol adipate (230 to 240° C./2 mmHg), di-2-ethylhexyl azelate (220 to 245° C./4 mmHg) and di-2-ethylhexyl sebacate (377° C./760 mmHg); examples of the phthalic acid ester-based compound include diethyl phthalate (298° C./760 mmHg), diheptyl phthalate (235 to 245° C./10 mmHg), di-n-octyl phthalate (210° C./760 mmHg) and diisodecyl phthalate (420° C./760 mmHg); and examples of the polyolefin-based compound include paraffin waxes (average molecular weight: from 330 to 600, melting point: from 45 to 80° C.) such as normal paraffin, isoparaffin and cycloparaffin, liquid paraffins (JIS-K2231 ISO VG8, ISO VG15, ISO VG32, ISO VG68, ISO VG100), paraffin pellets (melting point: from 56 to 58° C., from 58 to 60° C., from 60 to 62° C., etc.), chlorinated paraffin, low molecular polyethylene, low molecular polypropylene, low molecular polyisobutene, hydrogenated polybutadiene, hydrogenated polyisoprene and squalane.

The amount of the plasticizer added is preferably from 0.5 to 40.0 parts by mass, more preferably from 1.0 to 30.0 parts by mass, still more preferably from 3.0 to 20.0 parts by mass, per 100 parts by mass of the cyclic polyolefin-based resin. When the amount of the plasticizer added is not less than the lower limit above, the plasticizing effect is sufficient and there is no problem in the processing suitability. Also, when the amount added is not more than the upper limit above, for example, separation or dissolving out of the plasticizer, optical unevenness, or contamination of other parts does not occur with aging over a long time.

### [Production Method of Cyclic Polyolefin Film]

The production method of the cyclic polyolefin film of the present invention is described in detail below.

The production method of the film of the present invention is not particularly limited but includes a melt film-forming method and a solution film-forming method, and a solution film-forming method is preferred. Out of the solution film-forming methods, the cyclic polyolefin film is preferably produced by either one of the following two production methods.

1. A production method of a cyclic polyolefin film, comprising a step of dissolving or dispersing the cyclic polyolefin-based resin, at least one kind of the compound having a structure represented by formula (I) or (II), and at least one kind of a fine particle in a solvent, a step of casting the solution or dispersion, a step of drying the film, and a step of taking up the film.

2. A production method of a cyclic polyolefin film, comprising a step of dissolving the cyclic polyolefin-based resin and at least one kind of the compound having a structure represented by formula (I) or (II), a step of casting the solution, a step of drying the film, and a step of taking up the film, wherein the production method comprises a step of coating a coating solution containing at least one kind of a fine particle on at least one surface of the film after casting.

After the casting step, the film is preferably stretched.

These two production methods 1 and 2 differ in the manner of incorporating the fine particle into the cyclic polyolefin film. In the method of 1, the fine particle is dispersed in the same layer mainly comprising the cyclic polyolefin-based resin, whereas in the method of 2, a coating solution containing the fine particle is coated on the layer mainly comprising the cyclic polyolefin-based resin. The process from (dissolving step, preparation of dope) to (taking-up step after drying) is described in detail every each step, but the production method of 1 is the same as the production method of 2 except that the fine particle is dissolved, dispersed or added in the (dissolving step, preparation of dope).

### (Dissolving Step, Preparation of Dope)

Respective material components are dissolved in a solvent described later to prepare a cyclic polyolefin solution (dope). The preparation of a dope includes a method of dissolving the components with stirring at room temperature, a cooling dissolution method of swelling the cyclic polyolefin-based resin and the like with stirring at room temperature and after cooling to −20 to −100° C., again dissolving the components under heating to 20 to 100° C., a high-temperature dissolution method of dissolving the components at a temperature higher than the boiling point of the main solvent in a closed vessel, and a method of dissolving the components at high temperature and high pressure elevated to the critical point of the solvent. In the case where the cyclic polyolefin-based resin or the like has good solubility, room-temperature dissolution is preferred, but a cyclic polyolefin-based resin or the like having poor solubility is dissolved under heating in a closed vessel. When the solubility is not so bad, it is effective to select a temperature as low as possible.

In the present invention, the viscosity at 25° C. of the cyclic polyolefin solution is preferably from 1 to 500 Pa·s, more preferably from 5 to 200 Pa·s. The viscosity is measured as follows. A sample solution (1 mL) is measured using “Steel Cone” with a diameter of 4 cm/2° in a rheometer “CLS 500” (both manufactured by TA Instruments).

The sample solution is previously kept at the measurement initiating temperature until the liquid temperature becomes constant, and the measurement is then started.

The solvent used at the dope preparation is described below. In the present invention, the solvent which can be used is not particularly limited as long as the purpose can be achieved in the range where the cyclic polyolefin-based resin and the like can be dissolved, cast and film-formed. The solvent for use in the present invention is preferably a solvent selected from, for example, a chlorine-based solvent such as dichloromethane and chloroform, and a chain hydrocarbon, a cyclic hydrocarbon, an aromatic hydrocarbon, an ester, a ketone and an ether each having a carbon number of 3 to 12. The ester, ketone and ether each may have a cyclic structure. Examples of the chain hydrocarbons having a carbon number of 3 to 12 include hexane, octane, isooctane and decane, and examples of the cyclic hydrocarbons having a carbon number of 3 to 12 include cyclopentane, cyclohexane, and derivatives thereof. Examples of the aromatic hydrocarbon having a carbon number of 3 to 12 include benzene, toluene and xylene. Examples of the esters having a carbon number of 3 to 12 include ethyl formate, propyl formate, pentyl formate, methyl acetate, ethyl acetate and pentyl acetate. Examples of the ketones having a carbon number of 3 to 12 include acetone, methyl ethyl ketone, diethyl ketone, diisobutyl ketone, cyclopentanone, cyclohexanone and methylcyclohexanone. Examples of the ethers having a carbon number of 3 to 12 include diisopropyl ether, dimethoxyethane, dimethoxyethane, 1,4-dioxane, 1,3-dioxolane, tetrahydrofuran, anisole and phenetol. Examples of the organic solvent having two or more functional groups include 2-ethoxyethyl acetate, 2-methoxyethanol and 2-butoxyethanol. The boiling point of the organic solvent is preferably from 35 to 150° C. As regards the solvent for use in the present invention, a mixture of two or more kinds of solvents may be used for adjusting the physical properties of the solution, such as drying property and viscosity, and even a poor solvent can be added as long as the cyclic polyolefin-based resin and the like can dissolve in the mixed solvent.

The preferred poor solvent may be appropriately selected according to the polymer species used. In the case of using a chlorine-based organic solvent as the good solvent, alcohols may be suitably used. The alcohols are preferably an alcohol which may be linear, branched or cyclic, and more preferably a saturated aliphatic hydrocarbon. The hydroxyl group of the alcohol may be primary, secondary or tertiary. Examples of the alcohol include methanol, ethanol, 1-propanol, 2-propanol, 1-butanol, 2-butanol, tert-butanol, 1-pentanol, 2-methyl-2-butanol and cyclohexanol. Incidentally, a fluorine-based alcohol may also be used as the alcohol. Examples thereof include 2-fluoroethanol, 2,2,2-trifluoroethanol and 2,2,3,3-tetrafluoro-1-propanol. Among the poor solvents, monohydric alcohols are preferred because of their effect of decreasing the separation resistance. The preferred alcohols vary depending on the good solvent selected, but considering the drying load, an alcohol having a boiling point of 120° C. or less is preferred, a monohydric alcohol having a carbon number of 1 to 6 is more preferred, and alcohols having a carbon number of 1 to 4 are still more preferred. In preparing a solution by dissolving the cyclic polyolefin-based resin and the like, the mixed solvent used therefor is preferably a combination such that the main solvent is dichloromethane and the poor solvent is one or more alcohols selected from methanol, ethanol, propanol, isopropanol and butanol.

The cyclic polyolefin solution is characterized in that a high-concentration dope is obtained by appropriately selecting the solvent used, and a high-concentration cyclic polyolefin solution having excellent stability can be obtained even without relying on the means of concentration. In order to more facilitate the dissolution, after dissolving the components to a low concentration, the solution may be concentrated by using the concentrating means. The method for concentrating the solution is not particularly limited but the solution can be concentrated, for example, by a method of introducing a low-concentration solution between a cylindrical body and a rotation trajectory of the outer circumference of a rotary blade rotating in the circumferential direction inside the cylindrical body and at the same time, creating a temperature difference from the solution, thereby obtaining a high-concentration solution while evaporating the solvent (see, for example, JP-A-4-259511); or a method of injecting a heated low-concentration solution into a vessel from a nozzle, flash-evaporating the solvent during traveling of the solution from the nozzle until reaching the inner wall of vessel, and extracting the solvent vapor from the vessel while extracting a high-concentration solution from the vessel bottom (see, for example, U.S. Pat. Nos. 2,541,012, 2,858,229, 4,414,341 and 4,504,355).

In advance of casting, foreign matters in the solution, such as undissolved material, dust and impurity, are preferably removed by filtration with use of an appropriate filter medium such as metal mesh or flannel. For the filtration of the cyclic polyolefin solution, a filter having an absolute filtration precision of 0.1 to 100 μm is used, and a filter having an absolute filtration precision of 0.5 to 25 μm is more preferred. The thickness of the filter is preferably from 0.1 μm to 10 mm, more preferably from 0.2 to 2 mm. In this case, the filtration pressure is preferably 1.6 MPa or less, more preferably 1.3 MPa or less, still more preferably 1.0 MPa or less, yet still more preferably 0.6 MPa or less. As for the filter medium, a conventionally known material such as glass fiber, cellulose fiber, filter paper and fluororesin (e.g., ethylene tetrafluoride resin) can be preferably used. Furthermore, ceramic, metal and the like may also be preferably used.

The viscosity of the cyclic polyolefin solution immediately before film formation may be sufficient if the solution can be cast at the film formation. Usually, the solution is preferably prepared to have a viscosity of 5 to 1,000 Pa·s, more preferably from 15 to 500 Pa·s, still more preferably from 30 to 200 Pa·s. At this time, the temperature is not particularly limited as long as it is a temperature at the casting, but the temperature is preferably from −5 to 70° C., more preferably from −5 to 35° C.

As regards the method and apparatus for the production of the cyclic polyolefin film of the present invention, the solution casting film-forming method and solution casting film-forming apparatus conventionally used for the production of cellulose triacetate film are used. The dope (cyclic polyolefin solution) prepared in a dissolving machine (kettle) is once stored in a storing kettle and finalized by removing the bubbles contained in the dope. The dope is supplied to a pressure-type die from the dope discharge port through, for example, a pressure-type quantitative gear pump capable of feeding a constant amount of solution with high precision by the number of rotations, and uniformly cast on an endlessly running metal support in the casting part from the mouth ring (slit) of the pressure-type die, and the damp-dry dope film (also called web) is peeled off from the metal support at the peeling point after nearly one round of the metal support. The obtained web is nipped by clips at both ends, dried through conveyance by a tenter, then conveyed by a roll group of a drying apparatus to complete the drying, and taken up to a predetermined length by a take-up machine. The combination of the tenter and the drying apparatus comprising a roll group varies depending on the purpose. In the solution casting film-forming method used for a functional protective film of electronic displays, in addition to the solution casting film-forming apparatus, a coating apparatus is added in many cases so as to apply surface treatment to the film, such as subbing layer, antistatic layer, antihalation layer and protective layer. Each production step is simply described below, but the present invention is not limited thereto.

It is preferred that the prepared cyclic polyolefin solution (dope) is cast on a metal drum or a metal support (band or belt) and the solvent is evaporated to form a film. The concentration of the dope before casting is preferably adjusted such that the cyclic polyolefin amount becomes from 10 to 35 mass %. The surface of the drum or band is preferably finished to provide a mirror state. The dope is preferably cast on a drum or band at a surface temperature of 30° C. or less. In particular, the metal support temperature is preferably from −50 to 20° C.

Furthermore, the cellulose acylate film-forming methods described in JP-A-2000-301555, JP-A-2000-301558, JP-A-7-032391, JP-A-3-193316, JP-A-5-086212, JP-A-62-037113, JP-A-2-276607, JP-A-55-014201, JP-A-2-111511 and JP-A-2-208650 may be applied to the present invention.

### (Casting, Multilayer Casting)

In casting the cyclic polyolefin solution on a smooth band or drum working as a metal support, a single-layer solution may be cast or a plurality of cyclic polyolefin solutions in two or more layers may be cast.

In the case of casting a plurality of cyclic polyolefin solutions, respective cyclic polyolefin-containing solutions may be cast from a plurality of casting ports provided with a gap in the travelling direction of the metal support to produce a film while stacking the solutions one on another, and the methods described, for example, in JP-A-61-158414, JP-A-1-122419 and JP-A-11-198285 may be applied.

Also, cyclic polyolefin solutions may be cast from two casting ports to effect film formation and this can be practiced by the method described, for example, in JP-B-60-27562 (the term “JP-B” as used herein means an “examined Japanese patent publication”), JP-A-61-94724, JP-A-61-947245, JP-A-61-104813, JP-A-61-158413 and JP-A-6-134933. In addition, a cyclic polyolefin film casting method described in JP-A-56-162617 of encompassing the flow of a high-viscosity cyclic polyolefin solution with a low-viscosity cyclic polyolefin solution and simultaneously extruding the high-viscosity and low-viscosity cyclic polyolefin solutions may be used. A method of incorporating a larger amount of an alcohol component as a poor solvent into the solution on the outer side than into the solution on the inner side described in JP-A-61-94724 and JP-A-61-94725 is also a preferred embodiment. Furthermore, a film can be produced using two casting ports by separating a film cast from a first casting port and formed on a metal support, and applying second casting onto the film on the side contacted with the metal support surface, and this method is described, for example, in JP-B-44-20235. The cyclic polyolefin solutions cast may be the same or different and are not particularly limited. In order to impart functions to a plurality of cyclic polyolefin layers, a cyclic polyolefin solution according to the function may be extruded from each casting port. The cyclic polyolefin solution may also be cast simultaneously with other functional layers (for example, adhesive layer, dye layer, antistatic layer, antihalation layer, matting agent layer, UV absorbing layer and polarizing layer).

In the case of a single-layer solution, a cyclic polyolefin solution with high concentration and high viscosity must be extruded so as to obtain a required film thickness, and the cyclic polyolefin solution here has bad stability and tends to cause a problem that a solid matter is generated to cause particle failure or poor planarity. For solving this problem, a plurality of cyclic polyolefin solutions are cast from casting ports, whereby high-viscosity solutions can be simultaneously extruded on the metal support and not only the planarity can be enhanced to enable production of a film with excellent surface state but also reduction in the drying load and elevation of the film production speed can be achieved by the virtue of using thick cyclic polyolefin solutions.

In the case of co-casting, the layers on the inner and outer sides are not particularly limited in the thickness, but the thickness on the outer side preferably occupies from 1 to 50%, more preferably from 2 to 30%, of the entire film thickness. Here, in the case where three or more layers are co-cast, the total thickness of the layer in contact with the metal support and the layer in contact with the air side is defined as the thickness on the outer side. In the case of co-casting, a cyclic polyolefin film having a laminate structure may also be produced by co-casting cyclic polyolefin solutions differing in the concentration of the above-described additives. For example, a cyclic polyolefin film having a constitution of skin layer/core layer/skin layer can be produced. The deterioration inhibitor and ultraviolet absorbent may be incorporated in a larger amount into the core layer than into the skin layer or may be incorporated only into the core layer. The deterioration inhibitor and ultraviolet absorbent each may vary the kind between the core layer and the skin layer and, for example, a low-volatile deterioration inhibitor and/or ultraviolet absorbent may be incorporated into the skin layer, while adding a plasticizer with excellent plasticity or an ultraviolet absorbent with excellent ultraviolet absorptivity into the core layer. It is also a preferred embodiment to incorporate a separation accelerator only into the skin layer on the metal support side. In addition, an alcohol as a poor solvent may be added in a larger amount into the skin layer than into the core layer so as to gel the solution by cooling the metal support according to a cooling drum method, and this is preferred. The Tg may differ between the skin layer and the core layer, and the Tg of the core layer is preferably lower than the Tg of the skin layer. The viscosity of the cyclic polyolefin-containing solution at the casting may also be different between the skin layer and the core layer, and the viscosity of the skin layer is preferably lower than the viscosity of the core layer, but the viscosity of the core layer may be lower than the viscosity of the skin layer.

### (Casting)

Examples of the method for casting the solution include a method of uniformly extruding the prepared dope on a metal support from a pressure die, a doctor blade method of controlling the thickness of the dope once cast on a metal support by using a blade, and a reverse roll coater method of controlling the thickness by using a roll rotating in reverse. Among these, the method using a pressure die is preferred. The pressure die includes a coat hanger die, a T-die and the like, and any of these can be preferably used. Other than the methods described above, conventionally known various methods for casting and film-forming a cellulose triacetate solution can be employed, and the same effect as that described in each publication can be obtained by setting respective conditions while taking into account the difference in the boiling point or the like of the solvent used. The endlessly running metal support used in producing the cyclic polyolefin film of the present invention is a drum with the surface being mirror-finished by chromium plating or a stainless steel belt (may also be called a band) mirror-finished by surface polishing. As for the pressure die, one unit or two or more units may be provided on the upper side of the metal support. The pressure die provided is preferably one or two unit(s). In the case of providing two or more units, the amount of the dope cast may be divided at various ratios among respective dies, or the dope may be supplied to the dies at respective ratios by a plurality of precision quantitative gear pumps. The temperature of the cyclic polyolefin solution used for casting is preferably from −10 to 55° C., more preferably from 25 to 50° C. In this case, the temperature may be the same in all steps or may differ among respective step portions. When the temperature differs, it may sufficient if the temperature immediately before casting is a desired temperature.

### (Drying)

In the production of the cyclic polyolefin film, the dope on the metal support may be generally dried, for example, by a method of blowing hot air from the surface side of the metal support (drum or band), that is, from the surface of the web on the metal support; a method of blowing hot air from the back surface of the drum or band; or a liquid heat transfer method of bringing a liquid at a controlled temperature into contact with the drum or band from the back surface opposite the dope casting surface, and heating the drum or belt through heat transfer, thereby controlling the surface temperature. The back-surface liquid heat transfer method is preferred. The metal support surface before casting may be at any temperature as long as it is lower than the boiling point of the solvent used for the dope. However, in order to accelerate the drying or deprive the solution of its fluidity on the metal support, the surface temperature is preferably set to a temperature 1 to 10° C. lower than the boiling point of the solvent having a lowest boiling point out of the solvents used. Incidentally, this does not apply to the case where the cast dope is cooled and peeled off without drying it.

### (Separation)

At the time of separating the damp-dry film from the metal support, if the separation resistance (separation load) is large, the film is irregularly elongated in the film-forming direction to cause unevenness in the optical anisotropy. Particularly, if the separation load is large, a portion stepwise elongated in the film-forming direction and an unelongated portion are alternately generated and the retardation comes to have a distribution. When this film is loaded on a liquid crystal display device, linear or belt-like unevenness appears. In order to prevent occurrence of such a problem, the film separation load is preferably 0.25 N or less per the film separation width of 1 cm. The separation load is more preferably 0.2 N/cm or less, still more preferably 0.15 N or less, yet still more preferably 0.10 N or less. When the separation load is 0.2 N/cm or less, unevenness attributable to separation is not recognized at all even in a liquid crystal display device where unevenness is liable to appear, and this is preferred. The method for reducing the separation load include a method of adding a release agent as described above and a method of selecting the solvent composition used.

The separation load is measured as follows. The dope is dropped on a metal plate of which material and surface roughness are the same as those of the metal support of the film-forming apparatus, extended to even thickness by using a doctor blade and dried. Cuts of equal width are made in the film by a cutter, both ends of the film are stripped by hand and nipped with clips connected to a strain gauge, and while raising the strain gage obliquely to the 45° direction, the change in load is measured. The volatile content in the separated film is also measured. The same measurement is repeated several times by changing the drying time, and the separation load when the volatile content is the same as the residual volatile content at the separation in the actual film-forming process is set. The separation load tends to be larger as the separation rate increases, and the measurement is preferably performed at a separation rate close to the actual separation rate.

The residual volatile content concentration at the separation is preferably from 5 to 60 mass %, more preferably from 10 to 50 mass %, still more preferably from 20 to 40 mass %. When the film with high volatile content is separated, the drying speed can be shortened and the productivity is advantageously increased, but the film with high volatile content is low in the strength and elasticity and may be broken or elongated under the separation force. Also, the self-holding force after separation is poor to readily cause deformation, wrinkling or knicking, and this may give rise to generation of a distribution in the retardation.

### (Stretching Treatment)

In the case of stretching the cyclic polyolefin film of the present invention, the stretching treatment is preferably performed in the state of the solvent being still sufficiently remaining in the film immediately after the separation. The stretching is performed for the purpose of (1) obtaining a film with excellent planarity free of wrinkling or deformation, and (2) increasing the in-plane retardation of the film. The stretching treatment for the purpose of (1) is performed at a relatively high temperature at a low stretch ratio of 1% to at most 10%. Stretching of 2 to 5% is preferred. The stretching treatment for both purposes of (1) and (2) or for only the purpose of (2) is performed at a relatively low temperature at a stretch ratio of 5 to 150%.

The film stretching may be uniaxial stretching only in the vertical or transverse direction or may be simultaneous or sequential biaxial stretching. The birefringence of the optically-compensatory film for VA liquid crystal cell or OCB liquid crystal cell is preferably such that the refractive index in the crosswise direction is larger than the refractive index in the length direction. Therefore, the stretching is preferably performed at a larger stretch ratio in the crosswise direction.

### (Post-Drying, Taking-Up Step)

The cyclic polyolefin film after stretching is further dried to reduce the residual volatile content to 2% or less and then taken up.

The film thickness may be adjusted to the desired thickness by controlling the solid content concentration in the dope, the slit gap of mouth ring of the die, the extrusion pressure from the die, the metal support speed, or the like. The width of the thus-obtained cyclic polyolefin film is preferably from 0.5 to 3 m, more preferably from 0.6 to 2.5 m, still more preferably from 0.8 to 2.2 m. When the film width is 0.5 m or more, the productivity does not decrease, and when the film width is 3 m or less, worsening of web handleability or reduction in the optical uniformity of film is not generated or a disadvantageous phenomenon such as twisting and streak does not occur in the film and this is preferred. The film is preferably taken up to a length of 100 to 10,000 m, more preferably from 500 to 7,000 m, still more preferably from 1,000 to 6,000 m, per one roll. When the film length is 100 m or more, the productivity does not decrease due to increase in the frequency of roll exchange, and when the film length is 10,000 m or less, worsening of web handleability or reduction in the optical uniformity of film is not generated or a disadvantageous phenomenon such as twisting and streak does not occur in the film and this is preferred. At the time of taking up the film, knurling is preferably imparted to at least one edge, and the width of knurling is from 3 to 50 mm, more preferably from 5 to 30 mm, and the height is from 0.5 to 500 μm, more preferably from 1 to 200 μm. The knurling may be provided by either one-sided pressing or double-sided pressing. The fluctuation of Re value in the entire width is preferably ±5 nm, more preferably ±3 nm. Also, the fluctuation of Rth value is preferably ±10 nm, more preferably ±5 nm. Furthermore, the fluctuation of Re value or Rth value in the length direction is also preferably in the range of fluctuation in the width direction. In order to keep the transparent texture, the haze is preferably from 0.01 to 2%.

### (Heat-Melt Film-Forming Method)

The heat-melt film-forming method is described below. This method usually comprises steps of extruding a melted cyclic olefin-based resin into a sheet form from the die of an extruder, and cooling it to form a substrate film composed of cyclic olefin-based resin. Preferred embodiments of the heat-melt film-forming method are described below, but the present invention is not limited thereto.

In this production method, in the case of melting the cyclic olefin-based resin, the cyclic olefin-based resin pellet may be preheated. The preheating temperature is preferably from Tg−90° C. to Tg+15° C., more preferably from Tg−75° C. to Tg−5° C., still more preferably from Tg−70° C. to Tg−5° C. When the pellet is preheated at Tg−90° C. to Tg+15° C., the subsequent melt kneading of the resin can be uniformly performed.

In the production method above, after the preheating, the cyclic olefin-based resin is melted together with at least one compound having a structure represented by formula (I) or (II) in an extruder preferably by elevating the temperature to 200 to 300° C. At this time, the temperature on the outlet side of the extruder is preferably set to be higher than the temperature on the inlet side by 5 to 100° C., more preferably by 20 to 90° C., still more preferably by 30 to 80° C. When the temperature on the outlet side of the extruder is set to be higher than the temperature on the inlet side, the melted resin can be uniformly kneaded.

In the production method above, the melted cyclic olefin-based resin is then passed through a gear pump to remove pulsation of the extruder, filtered through a metal mesh filter or the like, extruded into a sheet form on a cooling roll from the T-die equipped to the extruder, and pressed on the cooling roll preferably in the region of 1 to 50%, more preferably from 2 to 40%, still more preferably from 3 to 30%, in the film width direction of the cyclic olefin-based resin film extruded. Preferably, the film is pressed uniformly from both end sides in the film width direction and the region of 1 to 50% in the film width direction is pressed.

When the extruded film is pressed over the entire surface of the cooling roll as in conventional methods, cooling unevenness ascribable to pressing unevenness or temperature unevenness of the cooling roll may be locally generated and such a non-uniform shrinkage stress cannot be expelled out of the film because the film is pressed over the entire surface. Also, when the entire surface of the film extruded is pressed to the cooling roll, the film temperature abruptly drops, and this may bring about Re unevenness and Rth unevenness, particularly, Rth unevenness. In order to solve this problem, when the above-described method and pressing are employed, the cyclic olefin-based resin film can get rid of a non-uniform shrinkage stress, and Re unevenness and Rth unevenness can be successfully prevented from occurring.

In the production method above, the pressing method is not particularly limited and, for example, a method such as air chamber, vacuum nozzle, electrostatic pinning and touch roll may be used. At this time, the pressure is not particularly limited but is preferably from 0.001 to 20 kg/cm² (from 98 Pa to 1.96 MPa), more preferably from 0.01 to 1 kg/cm² (from 980 Pa to 98 kPa).

In the production method above, the pressing may be performed while cooling on the cooling roll. At this time, the cooling is preferably performed as slow as possible. In the film-forming method generally performed, the cooling is performed at a rate of 50° C./sec or more, but in the production method above, the cooling rate is suitably from 0.2 to 20° C./sec, preferably from 0.5 to 15° C./sec, more preferably from 1 to 10° C./sec. By cooling the film at this cooling rate, generation of local cooling unevenness, creation of shrinkage stress due to abrupt shrinkage, and development of Re unevenness and Rth unevenness can be suppressed.

The cooling above (gradual cooling) is preferably achieved by keeping warm the inside of the casing for the cooling roll or adjusting the temperature of the cooling roll. A preferred effect is obtained in the former.

The keeping warm in the inside of the casing for the cooling roll can be achieved by disposing, in the casing, at least one cooling roll preferably regulated to a temperature of Tg−100° C. to Tg+30° C., more preferably from Tg−80° C. to Tg+10° C., still more preferably from Tg−70° C. to Tg. The film-formed sheet on the cooling roll is constrained by the frictional force and cannot be freely shrunk and therefore, Re unevenness and Rth unevenness are readily generated by the shrinkage stress attributable to the constrained state. However, when this method is used, the film can be uniformly and gradually cooled in the width direction and the temperature unevenness on the cooling roll can be reduced, as a result, Re unevenness and Rth unevenness can be made small.

Incidentally, a method of regulating the temperature between the T-die and the cooling drum (air gap) is disclosed in JP-A-2003-131006, and this method may also be applied.

Furthermore, in order to reduce Re unevenness and Rth unevenness, for example, the following methods can be preferably used in combination, but the present invention is not limited thereto.

(1) The cyclic olefin-based resin extruded into a sheet form from the die equipped with the extruder is cast on at least from 2 to 10 cooling rolls, preferably from 2 to 6 cooling rolls, more preferably 3 or 4 cooling rolls (dense roll), which are disposed at regular intervals. When the cooling temperature is controlled by using a plurality of cooling rolls in this way, the cooling rate can be easily adjusted. Also, by disposing the cooling rolls at regular intervals, the change in the temperature between cooling rolls can be reduced.

The distance between cooling rolls (distance between closest portions on the outer circumference of adjacent rolls) is preferably from 0.1 to 15 cm, more preferably from 0.3 to 10 cm, still more preferably from 0.5 to 5 cm.

(2) Out of those 2 to 10 cooling rolls, the temperature of at least the first cooling roll is preferably set to Tg (of cyclic olefin-based resin) −40° C. to Tg (more preferably from Tg−35° C. to Tg−3° C., still more preferably from Tg−30° C. to Tg−3° C., and most preferably from Tg−30° C. to Tg−5° C.). The temperature of the second cooling roll is preferably higher than that of the first cooling roll by 1 to 30° C. (more preferably by 1 to 20° C., still more preferably by 1 to 10° C.). By setting the temperature of the second cooling roll to be higher than that of the first cooling roll, the viscosity of the cyclic olefin-based resin can be more increased, and the adhesion to the second cooling roll can be enhanced, whereby slippage on the cooling roll and in turn, conveyance tension unevenness can be suppressed and therefore, Re and Rth unevenness can be reduced.

(3) The conveyance speed of the second cooling roll is preferably made higher than the conveyance speed of the first cooling roll by 0.1 to 5% (more preferably by 0.2 to 4%, still more preferably by 0.3 to 3%), whereby slippage between the first cooling roll and the second cooling roll can be suppressed and therefore, the conveyance tension unevenness and in turn, Re and Rth unevenness can be reduced.

(4) After passing the second cooling roll, the film is preferably passed through a third cooling roll at a temperature lower than that of the second cooling roll by 1 to 30° C. (more preferably by 1.5 to 20° C., still more preferably by 2 to 10° C.), whereby the cooling rate in the subsequent step of separating the cyclic olefin-based resin film from the cooling roll can be decreased and therefore, Re and Rth unevenness can be reduced. Furthermore, the conveyance speed of the third cooling roll is preferably made lower than the conveyance speed of the second cooling roll by 0.1 to 5% (more preferably from 0.2 to 4%, still more preferably by 0.3 to 3%), whereby the conveyance tension unevenness between the second cooling roll and the third cooling roll can be buffered and therefore, Re and Rth unevenness can be reduced.

The production method above may further comprise a step of separating the cyclic olefin-based resin film from the cooling roll after cooling the cyclic olefin-based resin film by the above-described method preferably at a cooling rate of 0.2 to 20° C./sec.

The separated cyclic olefin-based resin film may be conveyed using a plurality of conveying rolls disposed at an interval of preferably from 0.2 to 10 m, more preferably from 0.3 to 8 m, still more preferably from 0.4 to 6 m. By conveying the film under cooling over such a long span, the conveyance tension unevenness ascribable to friction with the conveying roll can be suppressed. At the cooling, the conveyance tension is unbalanced due to non-uniformity of the shrinkage amount between right and left and in order to relieve this unbalanced tension, a roll-to-roll distance large enough to allow free movement and buffering of the film is necessary. When the distance between conveying rolls is from 0.2 to 10 m, the cyclic olefin-based resin film can freely move without causing friction between the cyclic olefin-based resin film and the conveying roll, and slippage of the optical axis due to tension unevenness can be reduced.

The cyclic olefin-based resin film separated from the cooling roll is preferably cooled to 50° C. preferably at 0.1 to 3° C./sec, more preferably from 0.2 to 2.5° C./sec, still more preferably 0.3 to 2° C./sec. When the film is cooled at 0.1 to 3° C./sec, slippage of the optical axis can be prevented from occurring due to abrupt shrinkage stress and resulting tension non-uniformity between right and left. The cooling rate can be controlled by passing the cyclic olefin-based resin film in a casing and setting the temperature of air blown into the casing to be lower on the downstream side than on the upstream side or further adjusting the temperature of conveying rolls on the upstream and downstream sides.

In the production method above, the film-forming rate is suitably from 40 to 150 m/min, preferably from 50 to 100 m/min, more preferably from 60 to 80 m/min. When the film-forming rate is from 40 to 150 m/min, air can be taken in between the first cooling roll and the cyclic olefin-based resin film, and pressing over the entire surface and in turn, Re and Rth unevenness can be suppressed.

The film-forming width is preferably from 0.5 to 3 m, more preferably from 1.5 to 2.8 m, still more preferably from 1.7 to 2.5 m. By virtue of film-forming in such a wide width, the shrinkage stress unevenness in the width direction can be suppressed in the conveying step after separating the cyclic olefin-based resin film from the cooling roll. That is, if the film-forming width is narrow, the tension unevenness generated can be hardly buffered in the width direction, but when the film-forming width is wide, the tension unevenness can be buffered in the width direction and the optical axis unevenness can be reduced.

By changing the film thickness and further incorporating the compound of the present invention, the controllable optical property region can be more enlarged.

The thickness of the cyclic polyolefin film of the present invention is preferably from 20 to 200 μm and in order to obtain a film with excellent suitability for production and processing, the thickness is more preferably from 40 to 100 μm, and most preferably from 40 to 80 μm.

### (Optical Properties of Cyclic Polyolefin Film)

Preferred optical properties of the cyclic polyolefin film of the present invention differ depending on the usage of film. Optical properties preferred in usage for a polarizing plate protective film or usage for an optically-compensatory film are described later by referring to respective items.

Desired optical properties of the cyclic polyolefin film of the present invention can be realized by appropriately controlling the structure of cyclic polyolefin-based resin or the like used, the kind and amount added of additive, the stretch ratio, or the process conditions such as residual volatile content at the separation.

In the present invention, Re(λ) and Rth(λ) indicate the in-plane retardation and the retardation in the thickness direction, respectively, at a wavelength of λ. Re(λ) is measured by making light at a wavelength of λnm to be incident in the film normal direction in KOBRA 21ADH or WR (manufactured by Oji Scientific Instruments).

In the case where the film measured is a film expressed by a uniaxial or biaxial refractive index ellipsoid, Rth(λ) is calculated by the following method.

The above-described Re(λ) is measured at 6 points in total by making light at a wavelength of λnm to be incident from directions inclined with respect to the film normal direction in 10° steps up to 50° on one side from the normal direction with the in-plane slow axis (judged by KOBRA 21ADH or WR) being used as the inclination axis (rotation axis) (when the slow axis is not present, an arbitrary direction in the film plane is used as the rotation axis) and based on the retardation values measured, assumed values of average refractive index and film thickness values input, Rth(λ) is calculated by KOBRA 21 ADH or WR.

In the above, when the film has a direction where the retardation value becomes zero at a certain inclination angle from the normal direction with the rotation axis being the in-plane slow axis, the retardation value at an inclination angle larger than that inclination angle is calculated by KOBRA 21ADH or WR after converting its sign into a negative sign.

Incidentally, after measuring the retardation values from two arbitrary inclined directions by using the slow axis as the inclination axis (rotation axis) (when the slow axis is not present, an arbitrary direction in the film plane is used as the rotation axis), based on the values obtained, assumed values of average refractive index and film thickness values input, Rth can also be calculated according to the following formulae (A) and (B).

$$Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} \qquad Formula ( A )$$

### Note:

Re(θ) above represents the retardation value in the direction inclined at an angle of θ from the normal direction.

In formula (A), nx represents the refractive index in the in-plane slow axis direction, ny represents the refractive index in the direction crossing with nx at right angles in the plane, nz represents the refractive index in the direction crossing with nx and ny at right angles, and d represents the thickness of the film.

$$Rth = [ \frac{nx + ny}{2} - nz ] \times d \qquad Formula ( B )$$

In the case where the film measured is a film incapable of being expressed by a uniaxial or biaxial refractive index ellipsoid or a film not having a so-called optic axis, Rth(λ) is calculated by the following method.

The above-described Re(λ) is measured at 11 points by making light at a wavelength of λnm to be incident from directions inclined with respect the film normal direction in 10° steps from −50° to +50° with the inclination axis (rotation axis) being the in-plane slow axis (judged by KOBRA 21ADH or WR) and based on the retardation values measured, assumed values of average refractive index and film thickness values input, Rth(λ) is calculated by KOBRA 21ADH or WR.

In the measurement above, as for the assumed value of average refractive index, the values described in Polymer Handbook (John Wiley & Sons, Inc.) and catalogues of various optical films can be used. The average refractive index of which value is unknown can be measured by an Abbe refractometer. The values of average refractive index of main optical films are as follows: cellulose acylate (1.48), cycloolefin polymer (1.52), polycarbonate (1.59), polymethyl methacrylate (1.49) and polystyrene (1.59). When such an assumed value of average refractive index and the film thickness are input, KOBRA 21ADH or WR calculates nx, ny and nz and from these calculated nx, ny and nz, Nz=(nx−nz)/(nx−ny) is further calculated.

In this calculation, an average refractive index n is required as a parameter, and a value measured by an Abbe refractometer (“Abbe Refractometer 2-T”, manufactured by ATAGO K.K.) is used therefor. In the present invention, unless otherwise indicated, the measurement wavelength is 590 nm.

A polarizing plate protective film and an optically-compensatory film each having the cyclic polyolefin film of the present invention, and a polarizing plate having the polarizing plate protective film are described below.

### (Phase Difference Film—Optically-Compensatory Film)

In the case of using the cyclic polyolefin film as a phase difference film, the range of Re or Rth differs according to the kind of the phase difference film, and the need is diversified. The cyclic polyolefin film is preferably used as an optically-compensatory film. The optically-compensatory film of the present invention may be the cyclic polyolefin film itself of the present invention or may have other constituent layers which are described later. It is also preferred that a substituent having large polarizability is contained in the molecule at an appropriate ratio.

The optical properties are preferably 0 nm≦Re≦300 nm and 0 nm≦Rth≦400 nm. In the case where the cyclic polyolefin film of the present invention is used as an optically-compensatory film, the optical properties are more preferably 0 nm≦Re≦100 nm and 40 nm≦Rth≦400 nm. In the case of VA mode, the optical properties are still more preferably 20 nm≦Re≦80 nm and 80 nm≦Rth≦400 nm, yet still more preferably 30 nm≦Re≦75 nm and 120 nm≦Rth≦250 nm. When the cyclic polyolefin film is used as an optically-compensatory film for VA mode, it is a more preferred embodiment in view of color shift at the black display time and viewing angle dependency of contrast that 50 nm≦Re≦75 nm and 180 nm≦Rth≦250 nm at the compensation by one optically-compensatory film sheet and 30 nm≦Re≦50 nm and 80 nm≦Rth≦140 nm at the compensation by two optically-compensatory film sheets.

### (Polarizing Plate Protective Film

In the case of using the cyclic polyolefin film of the present invention as a polarizing plate protective film, the in-plane retardation (Re) is preferably 5 nm or less, more preferably 3 nm or less. The retardation (Rth) in the thickness direction is preferably 50 nm or less, more preferably 35 nm or less, still more preferably 10 nm or less.

The polarizing plate protective film of the present invention may be the cyclic polyolefin film itself of the present invention or may have other constituent layers which are described later.

### (Polarizing Plate)

The polarizing plate usually comprises a polarizer and two transparent protective film sheets disposed on both sides thereto. In the polarizing plate of the present invention, the polarizing plate protective film of the present invention is used as both or one of those two protective films. In the case where the polarizing plate protective film of the present invention is used for only one protective film, a normal cellulose acetate film or the like may be used for the other protective film. The polarizer includes an iodine-based polarizer, a dye-based polarizer using a dichroic dye, and a polyene-based polarizer. The iodine-based polarizer and the dye-based polarizer are generally produced using a polyvinyl alcohol (PVA)-based film. PVA is a polymer material obtained by saponifying polyvinyl acetate and may contain a component copolymerizable with vinyl acetate, such as unsaturated carboxylic acid, unsaturated sulfonic acid, olefins and vinyl ethers. Furthermore, modified PVA containing an acetoacetyl group, a sulfonic acid group, a carboxyl group, an oxyalkylene group or the like may also be used.

The saponification degree of PVA is not particularly limited but in view of solubility or the like, the saponification degree is preferably from 80 to 100 mol %, more preferably from 90 to 100 mol %. The polymerization degree of PVA is not particularly limited but is preferably from 1,000 to 10,000, more preferably from 1,500 to 5,000.

The syndiotacticity of PVA is, as described in Japanese Patent 2,978,219, preferably 55% or more for improving durability, but as described in Japanese Patent 3,317,494, PVA having a syndiotacticity of 45 to 52.5% may also be preferably used.

In the case where the cyclic polyolefin film of the present invention is used as a polarizing plate protective film or a phase difference film, it is preferred that the film is subjected to a surface treatment described later and the treated surface of the film and a polarizer are then laminated together using an adhesive. The polarizing plate comprises a polarizer and protective films protecting both surfaces of the polarizer. Furthermore, a protect film is laminated to one surface of the polarizing plate and a separate film is laminated to the opposite surface. The protect film and separate film are used for protecting the polarizing plate, for example, at the shipment of polarizing plate or at the inspection of product. In this case, the protect film is laminated for protecting the polarizing plate surface and used on the side opposite the surface through which the polarizing plate is laminated to a liquid crystal plate. The separate film is used for covering the adhesive layer which is laminated to the liquid crystal plate, and used on the side of the surface through which the polarizing plate is laminated to the liquid crystal plate.

The polarizing plate protective film of the present invention is preferably laminated to a polarizer such that the transmission axis of the polarizer agrees with the slow axis of the polarizing plate protective film of the present invention. Incidentally, when a polarizing plate produced as a polarizing plate in the cross-Nicol state is evaluated, it is found that if the orthogonality precision between the slow axis of the polarizing plate protective film of the present invention and the absorption axis (axis crossing the transmission axis at right angles) of the polarizer exceeds 1°, the polarization degree performance as a polarizing plate in the cross-Nicol state decreases and light leakage occurs. In this case, when the polarizing plate is combined with a liquid crystal cell, a sufficiently high black level or contrast cannot be obtained. Accordingly, the slippage between the main refractive index nx direction of the polarizing plate protective film of the present invention and the transmission axis direction of the polarizing plate is preferably within 1°, more preferably within 0.5°.

The single plate transmittance TT, parallel transmittance PT and cross transmittance CT of the polarizing plate can be measured by UV3100PC (manufactured by Shimadzu Corporation). The measurement is performed in the range of 380 to 780 nm, and an average value of 10 measurements is used for all of the single plate, parallel and cross transmittances.

The endurance test of the polarizing plate is performed as follows in two modes, that is, (1) a polarizing plate alone and (2) a polarizing plate laminated to a glass through a pressure-sensitive adhesive. In the measurement of a polarizing plate alone, polarizing plates are combined such that the polarizing plate protective film is sandwiched between two polarizers, and two samples having the same crossing are prepared and measured. In the case of a polarizing plate laminated to a glass, two samples (about 5 cm×5 cm) obtained by laminating the polarizing plate on a glass such that the polarizing plate protective film comes to the glass side, are prepared. The single plate transmittance is measured by setting the film side of this sample to face the light source. Two samples are measured, and the average value thereof is used as the single plate transmittance. As for the polarizing performance, the single plate transmittance TT, parallel transmittance PT and cross transmittance CT are, in this order, preferably 40.5≦TT≦45, 32≦PT≦39.5 and CT≦1.5, more preferably 41.0≦TT≦44.5, 34≦PT≦39.0 and CT≦1.3. In the endurance test of the polarizing plate, the amount of change is preferably smaller.

### (Surface Treatment of Cyclic Polyolefin Film)

In the polarizing plate protective film of the present invention, the surface of the cyclic polyolefin film is preferably surface-treated so as to improve the adhesive property to the polarizer. As for the surface treatment, any method may be used as long as the adhesive property can be improved, but preferred examples of the surface treatment include a glow discharge treatment, an ultraviolet irradiation treatment, a corona treatment and a flame treatment. The glow discharge treatment as referred to herein is a so-called low-temperature plasma which occurs under a low-pressure gas. In the present invention, a plasma treatment under atmospheric pressure is also preferred. Other details of the glow discharge treatment are described in U.S. Pat. Nos. 3,462,335, 3,761,299 and 4,072,769, and British Patent 891,469. The method described in JP-T-59-556430 where the gas composition of discharge atmosphere is limited to only the gas species generated in a vessel when after starting the discharge, a polyester support itself is subjected to a discharge treatment, may also be used. Furthermore, the method described in JP-B-60-16614 where in performing a vacuum glow discharge treatment, the discharge treatment is performed by setting the film surface temperature to 80 to 180° C., can also be applied.

At the glow discharge treatment, the degree of vacuum is preferably from 0.5 to 3,000 Pa, more preferably from 2 to 300 Pa. The voltage is preferably from 500 to 5,000 V, more preferably from 500 to 3,000 V. The discharge frequency used is preferably from a direct current to several thousands MHz, more preferably from 50 Hz to 20 MHz, still more preferably from 1 kHz to 1 MHz. The discharge treatment intensity is preferably from 0.01 to 5 kV·A·min/m², more preferably from 0.15 to 1 kV·A·min/m².

In the present invention, it is also preferred to perform an ultraviolet irradiation process as the surface treatment. For example, this can be performed by the treatment method described in JP-B-43-2603, JP-B-43-2604 and JP-B-45-3828. The mercury lamp is preferably a high-pressure mercury lamp comprising a quartz tube and emitting ultraviolet light at a wavelength of 180 to 380 nm. With respect to the method of irradiating ultraviolet light, a high-pressure mercury lamp having a main wavelength of 365 nm can be used as the light source if there is no problem in performance of the support even when the surface temperature of the protective film elevates to around 150° C. In the case where a low-temperature treatment is required, a low-pressure mercury lamp having a main wavelength of 254 nm is preferred. An ozoneless-type high-pressure mercury lamp or low-pressure mercury lamp may also be used. With respect to the treating light intensity, as the treating light intensity is higher, the adhesive force between the thermoplastic saturated alicyclic structure-containing polymer film and the polarizer is more enhanced, but along with increase in the light intensity, there arises a problem that the film is colored and becomes brittle. Accordingly, in the case of a high-pressure mercury lamp having a main wavelength of 365 nm, the irradiation light intensity is preferably from 20 to 10,000 mJ/cm², more preferably from 50 to 2,000 mJ/cm². In the case of a low-pressure mercury lamp having a main wavelength of 254 nm, the irradiation light intensity is preferably from 100 to 10,000 mJ/cm², more preferably from 300 to 1,500 mJ/cm².

Furthermore, in the present invention, it is also preferred to perform a corona discharge treatment as the surface treatment. This can be performed by the treatment method described, for example, in JP-B-39-12838, JP-A-47-19824, JP-A-48-28067 and JP-A-52-42114. As for the corona discharge treatment apparatus, a solid-state corona treatment apparatus manufactured by Pillar, an LEPEL-type surface treatment apparatus, a VETAPHON-type treatment apparatus, and the like may be used. The treatment can be performed under atmospheric pressure in air. The discharge frequency at the treatment is preferably from 5 to 40 kV, more preferably from 10 to 30 kV, and the waveform is preferably an AC sine wave. The gap clearance between the electrode and the dielectric roll is preferably from 0.1 to 10 mm, more preferably from 1.0 to 2.0 mm. The discharge is performed in the upper portion of a dielectric support roller provided in the discharge zone, and the treating amount is preferably from 0.34 to 0.4 kV·A·min/m², more preferably from 0.344 to 0.38 kV·A·min/m².

In the invention, it is also preferable to perform a flame treatment as the surface treatment. The gas used may be a natural gas, a liquefied propane gas or a city gas, but the mixing ratio with air is important, because the effect of surface treatment by the flame treatment is considered to be brought by an active oxygen-containing plasma. This effect is governed by how much the plasma has activity (temperature) and oxygen which are important properties of flame. The governing factor is a gas/oxygen ratio and when reaction proceeds neither too much nor too little, the energy density becomes highest and the plasma exhibits aggressive activity. Specifically, the natural gas/air mixing ratio is, in terms of the volume ratio, preferably from 1/6 to 1/10, more preferably from 1/7 to 1/9, the liquefied propane gas/air mixing ratio is from 1/14 to 1/22, preferably from 1/16 to 1/19, and the city gas/air mixing ratio is from 1/2 to 1/8, preferably from 1/3 to 1/7. The flame treatment amount is from 1 to 50 kcal/m², preferably from 3 to 20 kcal/m². Also, the distance between the tip of inner flame of a burner and the film is preferably from 3 to 7 cm, more preferably from 4 to 6 cm. The nozzle shape of the burner is preferably a ribbon type of Flynn Burner Corporation (U.S.A.), a multi-opening type of Weiss (U.S.A.), a ribbon type of Aerogen (U.K.), a staggered multi-opening type of Kasuga Electric Works Ltd. (Japan), or a staggered multi-opening type of Koike Sanso Kogyo Co., Ltd. (Japan). The backup roll supporting the film in the flame treatment is a hollow roll, and the treatment is preferably performed all the time at a constant temperature of 20 to 50° C. under water cooling by passing cooling water through the roll.

The preferred degree of surface treatment varies depending upon the kind of surface treatment and the kind of cyclic polyolefin, but it is preferred that as a result of the surface treatment, the surface of the protective film subjected to the surface treatment comes to have a contact angle for pure water of less than 50°. The contact angle is more preferably from 25° to less than 45°. When the contact angle of the protective film surface for pure water is in the range above, good adhesive strength is obtained between the protective film and the polarizing film.

### (Adhesive)

In laminating together the polarizer comprising a polyvinyl alcohol-based film and the surface-treated cyclic polyolefin film as the polarizing plate protective film, an adhesive containing a water-soluble polymer is preferably used. Examples of the water-soluble polymer which is preferably used for the adhesive include a homopolymer or copolymer containing, as a constitutional element, an ethylenically unsaturated monomer such as N-vinylpyrrolidone, acrylic acid, methacrylic acid, maleic acid, β-hydroxyethyl acrylate, β-hydroxyethyl methacrylate, vinyl alcohol, methyl vinyl ether, vinyl acetate, acrylamide, methacrylamide, diacetone acrylamide and vinylimidazole; and also include polyoxyethylene, polyoxypropylene, poly-2-methyloxazoline, methyl cellulose, hydroxyethyl cellulose, hydroxypropyl cellulose and gelatin. Among these, PVA and gelatin are preferred in the present invention.

In the case of using PVA for the adhesive, preferred PVA properties are the same as preferred properties of PVA used in the polarizer above. In the present invention, a crosslinking agent is preferably further used in combination. In the case of using PVA for the adhesive, preferred examples of the crosslinking agent used in combination include a boric acid, a polyhydric aldehyde, a polyfunctional isocyanate compound and a polyfunctional epoxy compound. In the present invention, a boric acid is preferably used. In the case of using gelatin for the adhesive, for example, a so-called lime-treated gelatin, an acid-treated gelatin, an enzyme-treated gelatin, a gelatin derivative and a modified gelatin may be used. Among these gelatins, a lime-treated gelatin and an acid-treated gelatin are preferred. In the case of using gelatin for the adhesive, preferred examples of the crosslinking agent used in combination include an active halogen compound (for example, 2,4-dichloro-6-hydroxy-1,3,5-triazine and a sodium salt thereof), an active vinyl compound (for example, 1,3-bisvinylsulfonyl-2-propanol, 1,2-bisvinylsulfonylacetamidoethane, bis(vinylsulfonylmethyl)ether and a vinyl-based polymer having a vinylsulfonyl group in the side chain), N-carbamoylpyridinium salts (for example, (1-morpholinocarbonyl-3-pyridinio)methanesulfonate), and haloamidinium salts (for example, 1-(1-chloro-1-pyridinomethylene)pyrrolidinium 2-naphthalenesulfonate). In the present invention, an active halogen compound and an active vinyl compound are preferably used.

In the case using the crosslinking agent in combination, the amount of the crosslinking agent added is preferably from 0.1 parts by mass to less than 40 parts by mass, more preferably from 0.5 parts by mass to less than 30 parts by mass, per 100 parts by mass of the water-soluble polymer in the adhesive. It is preferred to coat the adhesive on at least one surface of the protective film or polarizer, thereby forming an adhesive layer, and then laminate the protective film and the polarizer together, and it is more preferred to coat the adhesive on the surface-treated surface of the protective film, thereby forming an adhesive layer, and laminate the protective film to the surface of the polarizer. The dry thickness of the adhesive layer is preferably from 0.01 to 5 μm, more preferably from 0.05 to 3 μm.

### (Antireflection Layer)

A functional layer such as antireflection layer is preferably provided on the transparent protective layer disposed on the side opposite the liquid crystal cell across the polarizing plate. Particularly, in the present invention, an antireflection layer obtained by stacking at least a light scattering layer and a low refractive index layer in this order on the transparent protective layer, or an antireflection layer obtained by stacking a medium refractive index layer, a high refractive index layer and a low refractive index layer in this order on the transparent protective film is suitably used. That is, the transparent protective film is preferably used as the transparent support on which the antireflection layer is stacked. Preferred examples thereof are described below.

Preferred examples of the antireflection layer obtained by providing a light scattering layer and a low refractive index layer on the transparent protective film are described below. In the light scattering layer, matting particles are preferably dispersed. The light scattering layer may have both an antiglare property and a hardcoat property and may comprise a single layer or a plurality of layers, for example, from 2 to 4 layers.

The antireflection layer is preferably designed to have a surface irregularity shape such that the centerline average roughness Ra is from 0.08 to 0.40 μm, the 10-point average roughness Rz is 10 times or less of Ra, the average peak-to-trough distance Sm is from 1 to 100 μm, the standard deviation of the protrusion height from the deepest portion of irregularities is 0.5 μm or less, the standard deviation of the average peak-to-trough distance Sm based on the centerline is 20 μm or less, and the plane at a tilt angle of 0 to 5° occupies 10% or more, because satisfactory antiglare property and visually uniform matted texture are achieved.

Also, when the color tint of reflected light under a C light source has a* value of −2 to 2 and b* value of −3 to 3 and the ratio of minimum reflectance to maximum reflectance in the range of 380 to 780 nm is from 0.5 to 0.99, the reflected light gives a neutral color tint and this is preferred. Furthermore, the b* value of transmitted light under a C light source is preferably adjusted to 0 to 3, because yellow tinting of white display when applied to a display device can be decreased.

In addition, when a lattice of 120 μm×40 μm is inserted between the surface light source and the antireflection layer and the brightness distribution on the film is measured, the standard deviation of the brightness distribution is preferably 20 or less, because glaring can be reduced when the film of the present invention is applied to a high-definition panel.

The antireflection layer preferably has optical properties such that the specular reflectivity is 2.5% or less, the transmittance is 90% or more, and the 60° glossiness is 70% or less, whereby the reflection of outside light can be inhibited and the visibility can be enhanced. In particular, the specular reflectivity is more preferably 1% or less, and most preferably 0.5% or less. Also, it is preferred that the haze is from 20 to 50%, the internal haze/entire haze value (ratio) is from 0.3 to 1, the decrease in the haze value after formation of the low refractive index layer from the haze value with layers up to the light scattering layer is within 15%, the clearness of transmitted image is from 20 to 50% with a comb width of 0.5 mm, and the vertical light transmittance/transmittance in the direction inclined at 2° from the vertical direction is from 1.5 to 5.0, because the high-definition LCD panel can be prevented from glaring or reduced in the blurring of characters or the like.

### (Low Refractive Index Layer)

The refractive index of the low refractive index layer in the antireflection layer is preferably from 1.20 to 1.49, more preferably from 1.30 to 1.44. Furthermore, in view of reducing the reflectance, the low refractive index layer preferably satisfies the following mathematical formula:

(m/4)/λ×0.7<n1d1<(m/4)/λ×1.3

In the formula, m is a positive odd number, n1 is the refractive index of the low refractive index layer, d1 is the film thickness (nm) of the low refractive index layer, and λ is the wavelength and is a value in the range of 500 to 550 nm.

The materials constituting the low refractive index layer are described below.

The low refractive index layer preferably contains a fluorine-containing polymer as the low refractive index binder. The fluorine polymer is preferably a fluorine-containing polymer in which the coefficient of dynamic friction is from 0.03 to 0.20, the contact angle for water is from 90 to 120°, and the slipping angle of pure water is 70° or less and which is crosslinked under heat or ionizing radiation. When the antireflection layer is loaded in an image display device, the peel force with a commercially available adhesive tape is preferably lower because a seal or memo attached can be easily peeled off, and the peel force is preferably 500 gf or less, more preferably 300 gf or less, and most preferably 100 gf or less. Also, as the surface hardness as measured by a microhardness meter is higher, the surface is less scratched. The surface hardness is preferably 0.3 GPa or more, more preferably 0.5 GPa or more.

Examples of the fluorine-containing polymer for use in the low refractive index layer include a hydrolysate of a perfluoroalkyl group-containing silane compound {e.g., (heptadecafluoro-1,1,2,2-tetrahydrodecyl)triethoxysilane}, a dehydrating condensate thereof, and a fluorine-containing copolymer in which a fluorine-containing monomer unit and a constituent unit for imparting crosslinking reactivity are contained as the constituent components.

Specific examples of the fluorine-containing monomer include fluoroolefins (e.g., fluoroethylene, vinylidene fluoride, tetrafluoroethylene, perfluorooctylethylene, hexafluoropropylene, perfluoro-2,2-dimethyl-1,3-dioxol), partially or completely fluorinated alkyl ester derivatives of (meth)acrylic acid (e.g., VISCOAT 6FM (produced by Osaka Organic Chemical Industry Ltd.), M-2020 (produced by Daikin Industries, Ltd.)), and completely or partially fluorinated vinyl ethers. Among these, perfluoroolefins are preferred and in view of refractive index, solubility, transparency, availability and the like, hexafluoropropylene is more preferred.

Examples of the constituent unit for imparting crosslinking reactivity include a constituent unit obtained by the polymerization of a monomer previously having a self-crosslinking functional group within the molecule, such as glycidyl(meth)acrylate and glycidyl vinyl ether; a constituent unit obtained by the polymerization of a monomer having a carboxyl group, a hydroxyl group, an amino group, a sulfo group or the like (such as (meth)acrylic acid, methylol(meth)acrylate, hydroxyalkyl(meth)acrylate, allyl acrylate, hydroxyethyl vinyl ether, hydroxybutyl vinyl ether, maleic acid and crotonic acid}; and a constituent unit obtained by introducing a crosslinking reactive group such as (meth)acryloyl group into the above-described constituent units by a polymer reaction (for example, the crosslinking reactive group can be introduced by causing an acrylic acid chloride to act on a hydroxyl group).

Other than the above-described fluorine-containing monomer unit and constituent unit for imparting crosslinking reactivity, for example, in view of solubility in solvent or transparency of film, a monomer not containing a fluorine atom may also be appropriately copolymerized. The monomer unit which can be used in combination is not particularly limited, and examples thereof include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrene derivatives (e.g., styrene, divinylbenzene, vinyltoluene, α-methylstyrene), vinyl ethers (e.g., methyl vinyl ether, ethyl vinyl ether, cyclohexyl vinyl ether), vinyl esters (e.g., vinyl acetate, vinyl propionate, vinyl cinnamate), acrylamides (e.g., N-tert-butylacrylamide, N-cyclohexylacrylamide), methacrylamides and acrylonitrile derivatives. With such a polymer, a hardening agent may be appropriately used in combination as described in JP-A-10-25388 and JP-A-10-147739.

### (Light Scattering Layer)

The light scattering layer is formed for the purpose of providing the film with light scattering property by surface scattering and/or internal scattering, and hardcoat property for enhancing the scratch resistance of the film. Accordingly, the light scattering layer is formed comprising a binder for imparting hardcoat property, a matting particle for imparting light scattering property, and, if desired, an inorganic filler for elevating the refractive index, preventing crosslinking shrinkage and intensifying the strength. In view of imparting hardcoat property and suppressing generation of curling or increase in the brittleness, the thickness of the light scattering layer is preferably from 1 to 10 μm, more preferably from 1.2 to 6 μm.

The binder of the light scattering layer is preferably a polymer having a saturated hydrocarbon chain or polyether chain as the main chain, more preferably a polymer having a saturated hydrocarbon chain as the main chain. Also, the binder polymer preferably has a crosslinked structure. The binder polymer having a saturated hydrocarbon chain as the main chain is preferably a polymer of an ethylenically unsaturated monomer. The binder polymer having a saturated hydrocarbon chain as the main chain and having a crosslinked structure is preferably a (co)polymer of a monomer having two or more ethylenically unsaturated groups. In order to obtain a binder polymer having a high refractive index, the monomer above where an aromatic ring or at least one atom selected from a halogen atom (except for fluorine), a sulfur atom, a phosphorus atom and a nitrogen atom is contained in the structure may also be selected.

Examples of the monomer having two or more ethylenically unsaturated groups include an ester of a polyhydric alcohol and a (meth)acrylic acid (for example, ethylene glycol di(meth)acrylate, butanediol di(meth)acrylate, hexanediol di(meth)acrylate, 1,4-cyclohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, polyurethane polyacrylate and polyester polyacrylate); an ethylene oxide-modified product of the ester above; vinylbenzene and a derivative thereof {for example, 1,4-divinylbenzene, 4-vinylbenzoic acid-2-acryloyl ethyl ester, 1,4-divinylcyclohexanone}; a vinylsulfone (for example, divinylsulfone); an acrylamide (for example, methylenebisacrylamide); and a methacrylamide. These monomers may be used in combination of two or more thereof.

Specific examples of the high refractive index monomer include bis(4-methacryloylthiophenyl)sulfide, vinylnaphthalene, vinylphenyl sulfide and 4-methacryloxyphenyl-4′-methoxyphenyl thioether. These monomers may also be used in combination of two or more thereof.

Such a monomer having an ethylenically unsaturated group can be polymerized by the irradiation of ionizing radiation or under heating, in the presence of a photoradical initiator or a thermal radical initiator.

Accordingly, the antireflection layer can be formed by preparing a coating solution containing a monomer having an ethylenically unsaturated group, a photoradical initiator or thermal radical initiator, a matting particle and an inorganic filler, applying the coating solution onto the transparent support, and curing the coating solution through a polymerization reaction under ionization radiation or heat. As for the photoradical initiator and the like, known materials can be used.

The polymer having a polyether as the main chain is preferably a ring-opened polymer of a polyfunctional epoxy compound. The ring-opening polymerization of a polyfunctional epoxy compound can be performed by the irradiation of ionizing radiation or under heating, in the presence of a photoacid generator or a heat-acid generator.

Accordingly, the antireflection layer can be formed by preparing a coating solution containing a polyfunctional epoxy compound, a photoacid generator or heat-acid generator, a matting particle and an inorganic filler, applying the coating solution onto the transparent support, and curing the coating solution through a polymerization reaction under ionizing radiation or heat.

A crosslinked structure may also be introduced into the binder polymer by using a monomer having a crosslinking functional group in place of or in addition to the monomer having two or more ethylenically unsaturated groups and by introducing the crosslinking functional group into the polymer and causing a reaction of the crosslinking functional group.

Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also, a vinylsulfonic acid, an acid anhydride, a cyanoacrylate derivative, a melamine, an etherified methylol, an ester, a urethane, and a metal alkoxide such as tetramethoxysilane can be used as the monomer for introducing a crosslinked structure. A functional group which exhibits crosslinking property as a result of decomposition reaction, such as blocked isocyanate group, may also be used. That is, the crosslinking functional group for use in the present invention may be a functional group which does no directly react but exhibits reactivity as a result of decomposition.

The binder polymer having such a crosslinking functional group is coated and then heated, whereby a crosslinked structure can be formed.

In the light scattering layer, a matting particle larger than the filler particle and having an average particle size of 1 to 10 μm, preferably 1.5 to 7.0 μm, such as inorganic compound particle or resin particle, is preferably contained for the purpose of imparting antiglare property.

Specific preferred examples of the matting particle include an inorganic compound particle such as silica particle and TiO₂ particle; and a resin particle such as acrylic particle, crosslinked acrylic particle, polystyrene particle, crosslinked styrene particle, melamine resin particle and benzoguanamine resin particle. Among these, a crosslinked styrene particle, a crosslinked acrylic particle, a crosslinked acrylstyrene particle and a silica particle are preferred. The shape of the matting particle may be either spherical or amorphous.

Furthermore, two or more matting particles differing in the particle diameter may be used in combination. A matting particle having a larger particle diameter can impart antiglare property, while imparting another optical property by a matting particle having a smaller particle diameter.

The particle diameter distribution of the matting particle is most preferably monodisperse, and individual particles preferably have the same particle diameter as much as possible. For example, when a particle having a particle diameter 20% or more larger than the average particle diameter is defined as a coarse particle, the percentage of coarse particles in the total number of particles is preferably 1% or less, more preferably 0.1% or less, still more preferably 0.01% or less. The matting particle having such a particle diameter distribution is obtained by classifying the particles after a normal synthesis reaction, and when the number of classifications is increased or the level of classification is elevated, a fine particle having a more preferred distribution can be obtained.

The matting particle is preferably contained in the light scattering layer such that the amount of the matting particle in the formed light scattering layer is from 10 to 1,000 mg/m², more preferably from 100 to 700 mg/m². The particle size distribution of the matting particle is measured by a Coulter counter method, and the measured distribution is reduced to a particle number distribution.

In the light scattering layer, for elevating the refractive index of the layer, an inorganic filler comprising an oxide of at least one metal selected from titanium, zirconium, aluminum, indium, zinc, tin and antimony and having an average particle diameter of 0.2 μm or less, preferably 0.1 μm or less, more preferably 0.06 μm or less, is preferably contained in addition to the above-described matting particle.

Conversely, for increasing the difference in the refractive index from the matting particle, a silicon oxide may be also preferably used in the light scattering layer using a high refractive index matting particle, so that the refractive index of the layer can be kept rather low. The preferred particle diameter is the same as that of the above-described inorganic filler.

Specific examples of the inorganic filler for use in the light scattering layer include TiO₂, ZrO₂, Al₂O₃, In₂O₃, ZnO, SnO₂, Sb₂O₃, ITO and SiO₂. Among these, TiO₂ and ZrO₂ are preferred from the standpoint of elevating the refractive index. It is also preferred to treat the inorganic filler surface by a silane coupling treatment or a titanium coupling treatment. A surface treating agent having a functional group capable of reacting with the binder species on the filler surface is preferably used. The amount of the inorganic filler added is preferably from 10 to 90%, more preferably from 20 to 80%, still more preferably from 30 to 75%, based on the entire mass of the light scattering layer. Such a filler causes no scattering because the particle diameter is sufficiently smaller than the wavelength of light, and the dispersion element obtained by dispersing the filler in the binder polymer behaves as an optically uniform material.

The mixture of the binder and the inorganic filler in the light scattering layer preferably has a bulk refractive index of 1.48 to 2.00, more preferably from 1.50 to 2.00, still more preferably from 1.50 to 1.80. The refractive index in this range can be obtained by appropriately selecting the kinds of the binder and inorganic filler and the amount ratio therebetween. How to select these can be easily known by previously performing an experiment.

Particularly, in order to prevent coating unevenness, drying unevenness, point defect or the like and ensure surface uniformity of the light scattering layer, the coating composition for the formation of the antiglare layer preferably contains either a fluorine-containing surfactant or a silicone-containing surfactant or both thereof. Above all, a fluorine-containing surfactant is preferred, because the effect of improving surface failures such as coating unevenness, drying unevenness and point defect of the antireflection layer can be brought out by the addition in a small amount. The purpose is to impart suitability for high-speed coating while enhancing the surface uniformity and thereby elevate the productivity.

The antireflection layer formed by stacking a medium refractive index layer, a high refractive index layer and a low refractive index layer in this order on the transparent protective film is described below.

The antireflection layer comprising a layer structure in the order of at least a medium refractive index layer, a high refractive index layer and a low refractive index layer (outermost layer) on the substrate is preferably designed to have a refractive index satisfying the following relationship:

refractive index of high refractive index layer>refractive index of medium refractive index layer>refractive index of transparent support>refractive index of low refractive index layer.

Also, a hardcoat layer may be provided between the transparent support and the medium refractive index layer. Furthermore, the antireflection layer may comprise a medium refractive index hardcoat layer, a high refractive index layer and a low refractive index layer (see, for example, JP-A-8-122504, JP-A-8-110401, JP-A-10-300902, JP-A-2002-243906 and JP-A-2000-111706). Other functions may be imparted to each layer, and examples of such a layer include an antifouling low refractive index layer and an antistatic high refractive index layer (see, for example, JP-A-10-206603 and JP-A-2002-243906).

The haze of the antireflection layer is preferably 5% or less, more preferably 3% or less. The surface strength of the film is, in a pencil hardness test according to JIS K5400, preferably H or more, more preferably 2H or more, and most preferably 3H or more.

### (High Refractive Index Layer and Medium Refractive Index Layer)

In the antireflection layer, the layer having a high refractive index preferably comprises a curable film containing at least a matrix binder and an inorganic compound ultrafine particle having an average particle diameter of 100 nm or less and a high refractive index.

The inorganic compound fine particle having a high refractive index includes, for example, an inorganic compound having a refractive index of 1.65 or more, preferably 1.9 or more. Examples thereof include an oxide of Ti, Zn, Sb, Sn, Zr, Ce, Ta, La or In, and a composite oxide containing such a metal atom.

Examples of the method for preparing such an ultrafine particle include a method of treating the particle surface with a surface-treating agent (such as silane coupling agent, see, for example, JP-A-11-295503, JP-A-11-153703 and JP-A-2000-9908; anionic compound or organic metal coupling agent, see, for example, JP-A-2001-310432), a method of constituting a core-shell structure using a high refractive index particle as the core (see, for example, JP-A-2001-166104 and JP-A-2001-310432), and a method using a specific dispersant in combination (see, for example, JP-A-11-153703, U.S. Pat. No. 6,210,858 and JP-A-2002-2776069).

Examples of the material for forming the matrix include conventionally known thermoplastic resin and curable resin films.

Furthermore, at least one composition selected from a polyfunctional compound-containing composition containing at least two or more radical and/or cation polymerizable groups; and a composition containing a hydrolyzable group-containing organic compound or its partial condensation product, is preferred. Examples thereof include compositions described in JP-A-2000-47004, JP-A-2001-315242, JP-A-2001-31871 and JP-A-2001-296401.

A colloidal metal oxide obtained from a hydrolysis condensate of a metal oxide, and a curable film obtained from a metal alkoxide composition are also preferred, and these are described, for example, in JP-A-2001-293818.

The refractive index of the high refractive index layer is preferably from 1.70 to 2.20, and the thickness of the high refractive index layer is preferably from 5 nm to 10 μm, more preferably from 10 nm to 1 μm. The refractive index of the medium refractive index layer is adjusted to a value between the refractive index of the low refractive index layer and the refractive index of the high refractive index layer. The refractive index of the medium refractive index layer is preferably from 1.50 to 1.70, and the thickness is preferably from 5 nm to 10 μm, more preferably from 10 nm to 1 μm.

### (Low Refractive Index Layer)

The low refractive index layer is sequentially stacked on the high refractive index layer. The refractive index of the low refractive index layer is preferably from 1.20 to 1.55, more preferably from 1.30 to 1.50.

The low refractive index layer is preferably constituted as an outermost layer having scratch resistance and antifouling property. For greatly enhancing the scratch resistance, it is effective to impart slipperiness to the surface, and conventionally known techniques for a thin film layer, such as introduction of silicone or introduction of fluorine, can be applied.

The refractive index of the fluorine-containing compound is preferably from 1.35 to 1.50, more preferably from 1.36 to 1.47. The fluorine-containing compound is preferably a compound containing from 35 to 80 mass % of a fluorine atom and having a crosslinking or polymerizable functional group. Examples thereof include the compounds described in JP-A-9-222503 (paragraphs [0018] to [0026]), JP-A-11-38202 (paragraphs [0019] to [0030]), JP-A-2001-40284 (paragraphs [0027] and [0028]) and JP-A-2000-284102.

The silicone compound is preferably a compound having a polysiloxane structure, which contains a curable functional group or a polymerizable functional group in the polymer chain and forms a bridged structure in the film. Examples thereof include a reactive silicone (e.g., SILAPLANE (produced by Chisso Corp.)) and a polysiloxane containing a silanol group at both ends (see, for example, JP-A-11-258403).

The crosslinking or polymerization reaction of a fluorine-containing and/or siloxane polymer having a crosslinking or polymerizable group is preferably performed by irradiating light or applying heat simultaneously with or after the coating of a coating composition containing a polymerization initiator, a sensitizer and the like for forming the outermost layer.

A sol/gel cured film which is cured by the condensation reaction of an organic metal compound such as silane coupling agent and a specific silane coupling agent containing a fluorine-containing hydrocarbon group, in the co-presence of a catalyst, is also preferred.

Examples thereof include a polyfluoroalkyl group-containing silane compound or a partial hydrolysis condensate thereof (e.g., compounds described in JP-A-58-142958, JP-A-58-147483, JP-A-58-147484, JP-A-9-157582 and JP-A-11-106704), and a silyl compound containing a poly(perfluoroalkyl ether) group which is a fluorine-containing long chain group (e.g., compounds described in JP-A-2000-117902, JP-A-2001-48590 and JP-A-2002-53804).

In addition to these additives, the low refractive index layer may contain a filler (for example, a low refractive index inorganic compound having an average primary particle diameter of 1 to 150 nm, such as silicon dioxide (silica), fluorine-containing particle (e.g., magnesium fluoride, calcium fluoride, barium fluoride), and an organic fine particle described in JP-A-11-3820, paragraphs [0020] to [0038]), a silane coupling agent, a slipping agent, a surfactant and the like.

In the case where the low refractive index layer underlies the outermost layer, the low refractive index layer may be formed by a vapor phase process (e.g., vacuum deposition, sputtering, ion plating, plasma CVD). In view of production at a low cost, a coating method is preferred. The thickness of the low refractive index layer is preferably from 30 to 200 nm, more preferably from 50 to 150 nm, and most preferably from 60 to 120 nm.

### (Other Layers of Antireflection Layer)

A hardcoat layer, a forward scattering layer, a primer layer, an antistatic layer, an undercoat layer, a protective layer and the like may be further provided.

### (Hardcoat Layer)

The hardcoat layer is provided on the transparent support surface so as to impart physical strength to the transparent protective film having provided thereon the antireflection layer. In particular, the hardcoat layer is preferably provided between the transparent support and the high refractive index layer. The hardcoat layer is preferably formed through a crosslinking or polymerization reaction of a photo- and/or heat-curable compound. The curable functional group is preferably a photopolymerizable functional group, and the hydrolyzable functional group-containing organic metal compound is preferably an organic alkoxysilyl compound.

Specific examples of these compounds include those described above for the high refractive index layer. Specific examples of the constitutional composition for the hardcoat layer include those described in JP-A-2002-144913, JP-A-2000-9908 and International Publication No. WO00/46617, pamphlet.

The high refractive index layer can serve also as a hardcoat layer. In such a case, the hardcoat layer is preferably formed containing fine particles finely dispersed by using the means described for the high refractive index layer.

The hardcoat layer can be made to serve also as an antiglare layer by incorporating particles having an average particle diameter of 0.2 to 10 μm and thereby imparting an antiglare function.

The thickness of the hardcoat layer can be appropriately designed according to the usage. The thickness of the hardcoat layer is preferably from 0.2 to 10 μm, more preferably from 0.5 to 7 μm.

The strength of the hardcoat layer is, in a pencil hardness test according to JIS K5400, preferably H or more, more preferably 2H or more, and most preferably 3H or more. Also, in a Taber test according to JIS K5400, the abrasion loss of a specimen between before and after the test is preferably smaller.

### (Antistatic Layer)

In the case of providing an antistatic layer, an electrical conductivity of 10⁻⁸ Ωcm⁻³ or less in terms of the volume resistivity is preferably imparted. A volume resistivity of 10⁻⁸ Ωcm⁻³ may be imparted using a hygroscopic substance, a water-soluble inorganic salt, a certain kind of surfactant, a cationic polymer, an anionic polymer, a colloidal silica or the like, but these have a problem that the temperature and humidity dependency is large and a sufficient electrical conductivity cannot be ensured at low humidity. Therefore, the material for the antistatic layer is preferably a metal oxide. Some metal oxides are colored and if such a metal oxide is used as the material for the antistatic layer, the film as a whole is disadvantageously colored. Examples of the metal for forming a non-colored metal oxide include Zn, Ti, Al, In, Si, Mg, Ba, Mo, W and V. A metal oxide mainly comprising such a metal is preferably used. Specific examples of the metal oxide include ZnO, TiO₂, SnO₂, Al₂O₃, In₂O₃, SiO₂, MgO, BaO, MoO₃, V₂O₅, and a composite oxide thereof. Among these, ZnO, TiO₂ and SnO₂ are preferred. In the case of containing a heteroatom, for example, addition of Al, In or the like is effective for ZnO, addition of Sb, Nb, halogen atom or the like is effective for SnO₂, and addition of Nb, TA or the like is effective for TiO₂. Furthermore, as described in JP-B-59-6235, a material prepared by attaching the above-described metal oxide to another crystalline metal particle or fibrous material (for example, titanium oxide) may also be used. Incidentally, the volume resistance value is a physical value different from the surface resistance value and these cannot be simply compared, but in order to ensure electrical conductivity of 10⁻⁸ Ωcm⁻³ or less in terms of the volume resistance value, it is sufficient if the antistatic layer has a surface resistance value of generally 10⁻¹⁰ Ω/square or less, preferably 10⁻⁸ Ω/square. The surface resistance value of the antistatic layer must be measured as a value when the antistatic layer is an outermost layer, and this value can be measured on the way of forming the laminate film described in the present invention.

The liquid crystal display device of the present invention, comprising at least one member of the above-described cyclic polyolefin film, polarizing plate protective film, optically-compensatory film and polarizing plate, is described below.

### (Liquid Crystal Display Device)

The cyclic polyolefin film of the present invention, the optically-compensatory film having the cyclic polyolefin film, and the polarizing plate using the cyclic polyolefin film can be used for liquid crystal cells and liquid crystal display devices in various display modes. There are proposed various display modes such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned), HAN (hybrid aligned nematic) and ECB (electrically controlled birefringence). Of these, the cyclic polyolefin film, optically-compensatory film or polarizing plate can be preferably used for IPS mode, ECB mode, OCB mode or VA mode.

### (IPS-Type Liquid Crystal Display Device and ECB-Type Liquid Crystal Display Device)

The cyclic polyolefin film of the present invention is advantageously used particularly as the support of an optically-compensatory sheet or the protective film of a polarizing plate in an IPS-type liquid crystal display device having an IPS-mode liquid crystal cell and an ECB-type liquid crystal display device having an ECB-mode liquid crystal cell. These modes are a mode of causing the liquid crystal material to align nearly in parallel at the black display time, where the liquid crystal molecules are aligned in parallel to the substrate plane in a voltage-unapplied state to provide black display. In these modes, the polarizing plate using the cyclic polyolefin film of the present invention contributes to enlargement of the viewing angle and betterment of the contrast.

### (OCB-Type Liquid Crystal Display Device)

The OCB-mode liquid crystal cell is a liquid crystal display device using a liquid crystal cell of bend alignment mode where rod-like liquid crystalline molecules are aligned substantially in opposite directions (symmetrically) between the upper part and the lower part of the liquid crystal cell. The OCB-mode liquid crystal cell is disclosed in U.S. Pat. Nos. 4,583,825 and 5,410,422. Since rod-like liquid crystalline molecules are aligned symmetrically between the upper part and the lower part of the liquid crystal cell, the liquid crystal cell of bend alignment mode has a self-optically compensating ability. Accordingly, this liquid crystal mode is also called an OCB (optically compensatory bend) liquid crystal mode. The liquid crystal display device of bend alignment mode is advantageous in that the response speed is fast.

### (VA-Type Liquid Crystal Display Device)

In the VA-mode liquid crystal cell, rod-like liquid crystalline molecules are oriented substantially in the vertical alignment when a voltage is not applied.

The VA-mode liquid crystal cell includes (1) a VA-mode liquid crystal cell in a narrow sense where rod-like liquid crystalline molecules are oriented substantially in a vertical alignment at the time of not applying a voltage and oriented substantially in a horizontal alignment at the time of applying a voltage (described in JP-A-2-176625); (2) a (MVA-mode) liquid crystal cell where the VA mode is modified to a multi-domain system for enlarging the viewing angle (described in SID97, Digest of Tech. Papers (preprints), 28, 845 (1997)); (3) a (n-ASM-mode) liquid crystal cell where rod-like liquid crystalline molecules are oriented substantially in a vertical alignment at the time of not applying a voltage and oriented in a twisted multi-domain alignment at the time of applying a voltage (described in preprints of Japan Liquid Crystal Symposium, 58-59 (1998)); and (4) a SURVAIVAL-mode liquid crystal cell (published in LCD International 98).

The VA-mode liquid crystal display device comprises a liquid crystal cell and two polarizing plates disposed on both sides of the liquid crystal cell. The liquid crystal cell carries a liquid crystal between two electrode substrates. In one embodiment of the transmissive liquid crystal display device of the present invention, one sheet of the optically-compensatory film of the present invention is disposed between the liquid crystal cell and one polarizing plate, or two sheets are disposed, that is, one sheet between the liquid crystal cell and one polarizing plate and another sheet between the liquid crystal cell and another polarizing plate.

In another embodiment of the transmissive liquid crystal display device of the present invention, an optically-compensatory sheet comprising the cyclic polyolefin film of the present invention is used as the transparent protective film of the polarizing plate, which is disposed between the liquid crystal cell and the polarizer. That is, the transparent protective film of the polarizing plate can serve also as the optically-compensatory film. The optically-compensatory film may be used only as the transparent protective film (between the liquid crystal cell and the polarizer) of one polarizing plate, or the optically-compensatory film may be used for two transparent protective films (between the liquid crystal cell and the polarizer) of both polarizing plates. In the case of using the optically-compensatory film only for one polarizing plate, the optically-compensatory film is preferably used as the liquid crystal cell-side protective film of the backlight-side polarizing plate of the liquid crystal cell. The lamination to the liquid crystal cell is preferably performed by arranging the cyclic polyolefin film of the present invention on the VA cell side. The other protective film may be a cellulose acylate film usually employed. For example, a film having a thickness of 40 to 80 μm is preferred. Examples of the commercially available product therefor include, but are not limited to, KC4UX2M (produced by Konica Opto Corp., 40 μm), KC5UX (produced by Konica Opto Corp., 60 μm), and TD80 (produced by Fujifilm Corp., 80 μm).

In the OCB-mode liquid crystal display device or TN liquid crystal display device, an optically-compensatory film is used for enlarging the viewing angle. The optically-compensatory film used for OCB cell is obtained by fixing a discotic liquid crystal in hybrid alignment on an optically uniaxial or biaxial film, thereby providing an optically anisotropic layer, and the optically-compensatory film used for TN cell is obtained by fixing a discotic liquid crystal in hybrid alignment on a film having optical isotropy or having an optical axis in the thickness direction, thereby providing an optically anisotropic layer. The cyclic polyolefin film of the present invention is useful also for the preparation of an optically-compensatory film for OCB cell or TN cell.

### EXAMPLES

The present invention is described in greater detail below by referring to Examples, but the present invention is not limited to these Examples.

### [Evaluation of Physical Properties of Cyclic Polyolefin]

Various properties of the film are measured by the following methods and evaluated.

### (Retardation)

The retardation is measured by KOBRA 21ADH (manufactured by Oji Test Instruments).

### [Haze of Film]

The haze of the cyclic polyolefin film of the present invention is preferably from 0.01 to 2.0%, more preferably from 0.05 to 1.5%, still more preferably from 0.1 to 1.0%. The transparency of film is important as an optical film. In the measurement of haze, a sample (40 mm×80 mm) of the cyclic polyolefin film of the present invention is measured at 25° C. and 60% RH by a haze meter (HGM-2DP, manufactured by Suga Test Instruments Co., Ltd.) according to JIS K-6714.

### [Calculation of Solubility Parameter (SP Value)]

The solubility parameters (SP values) used in the present invention all are a value calculated by the Hoy's method.

### <Synthesis of Cyclic Polyolefin Polymer P-1>

100 Parts by mass of purified toluene and 100 parts by mass of methyl norbornenecarboxylate are charged into a reaction kettle. Subsequently, 25 mmol % (based on monomer) of ethyl hexanoate-Ni dissolved in toluene, 0.225 mol % (based on monomer) of tri(pentafluorophenyl)boron, and 0.25 mol % (based on monomer) of triethylaluminum dissolved in toluene are charged into the reaction kettle. The reaction is allowed to proceed for 18 hours under stirring at room temperature. After the completion of reaction, the reaction mixture is poured into excess ethanol to produce a polymer precipitate. The precipitate is purified and the obtained Cyclic Polyolefin Polymer (P-1) is dried by vacuum drying at 65° C. for 24 hours.

The polymer obtained is dissolved in tetrahydrofuran, and the molecular weight is measured by gel permeation chromatograph, as a result, in terms of polystyrene, the number average molecular weight is 79,000 and the weight average molecular weight is 205,000. The refractive index of the obtained polymer is measured by an Abbe refractometer and found to be 1.52.

### Example 1

(Polyolefin Dope D-1)

| | |
|---|---|
| Cyclic Polyolefin Polymer P-1 | 150 parts by mass |
| Additive: polymethyl acrylate (“ACTFLOW | 7.5 parts by mass |
| UMM1001”, produced by The Soken Chemical | |
| & Engineering Co., Ltd., weight average | |
| molecular weight Mw: about 1,000) | |
| Deterioration inhibitor: “IRGANOX 1010” | 0.45 parts by mass |
| produced by Ciba Specialty Chemicals | |
| Dichloromethane | 620 parts by mass |

The composition above is charged into a mixing tank and stirred to dissolve respective components, and the resulting solution is filtered through filter paper having an average pore size of 34 μm and further through a sintered metal filter having an average pore size of 10 μm to prepare Cyclic Polyolefin Dope D-1. The dope is cast by a band casting machine and when the residual solvent amount is about 30 mass %, the film is separated from the band and dried by blowing hot air at 140° C. in a tenter. Thereafter, the conveyance is transferred to roll conveyance from tenter conveyance, and the film is further dried at 120 to 140° C. and then taken up. At this time, the film thickness is 80 μm. The Re retardation and Rth retardation of the produced film are measured by KOBRA 21ADH (manufactured by Oji Test Instruments).

### Example 2

A cyclic olefin-based resin film is obtained in the same manner as in Example 1 except that in Example 1, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 3

Preparation of Dope D-2 and production of film are performed in the same manner as in Example 1 except that in Example 1, the amount of the additive added is changed to 15 parts by mass. The evaluation results of the film obtained are shown in Table 1.

### Example 4

A cyclic olefin-based resin film is obtained in the same manner as in Example 1 except that in Example 3, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 5

Preparation of Dope D-3 and production of film are performed in the same manner as in Example 1 except that in Example 1, the amount of the additive added is changed to 30 parts by mass. The evaluation results of the film obtained are shown in Table 1.

### Example 6

A cyclic olefin-based resin film is obtained in the same manner as in Example 1 except that in Example 5, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 7

Preparation of Dope D-4 and production of film are performed in the same manner as in Example 1 except that in Example 1, the amount of the additive added is changed to 45 parts by mass. The evaluation results of the film obtained are shown in Table 1.

### Example 8

A cyclic olefin-based resin film is obtained in the same manner as in Example 1 except that in Example 7, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 9

Preparation of Dope D-5 and production of film are performed in the same manner as in Example 1 except that in Example 1, the amount of the additive added is changed to 60 parts by mass. The evaluation results of the film obtained are shown in Table 1.

### Example 10

A cyclic olefin-based resin film is obtained in the same manner as in Example 1 except that in Example 9, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 11

Preparation of Dope D-6 and production of film are performed in the same manner as in Example 1 except that in Example 3, the additive is changed to “ARUFON UP-1010” (weight average molecular weight Mw: about 1,700) produced by Toagosei Co., Ltd. The evaluation results of the film obtained are shown in Table 1.

### Example 12

A cyclic olefin-based resin film is obtained in the same manner as in Example 1 except that in Example 11, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 13

Preparation of Dope D-7 and production of film are performed in the same manner as in Example 1 except that in Example 3, the additive is changed to polymethyl methacrylate (#81497, produced by Aldrich, weight average molecular weight Mw: about 10,000). The evaluation results of the film obtained are shown in Table 1.

### Example 14

A cyclic olefin-based resin film is obtained in the same manner as in Example 1 except that in Example 13, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 15

Preparation of Dope D-8 and production of film are performed in the same manner as in Example 1 except that in Example 1, the additive is changed to polystyrene (#327824, produced by Aldrich, weight average molecular weight Mw: about 800). The evaluation results of the film obtained are shown in Table 1.

### Example 16

A cyclic olefin-based resin film is obtained in the same manner as in Example 1 except that in Example 15, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 17

Preparation of Dope D-9 and production of film are performed in the same manner as in Example 1 except that in Example 3, the additive is changed to polystyrene (#327824, produced by Aldrich, weight average molecular weight Mw: about 800). The evaluation results of the film obtained are shown in Table 1.

### Example 18

A cyclic olefin-based resin film is obtained in the same manner as in Example 1 except that in Example 17, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 19

Preparation of Dope D-10 and production of film are performed in the same manner as in Example 1 except that in Example 3, the additive is changed to polystyrene (#327719, produced by Aldrich, weight average molecular weight Mw: about 2,500) and the amount of the additive added is changed to 4.5 mass %. The evaluation results of the film obtained are shown in Table 1.

### Example 20

A cyclic olefin-based resin film is obtained in the same manner as in Example 1 except that in Example 19, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 21

Preparation of Dope D-11 and production of film are performed in the same manner as in Example 1 except that in Example 3, the additive is changed to polystyrene (#327719, produced by Aldrich, weight average molecular weight Mw: about 2,500). The evaluation results of the film obtained are shown in Table 1.

### Example 22

A cyclic olefin-based resin film is obtained in the same manner as in Example 1 except that in Example 21, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 23

Preparation of Dope D-12 and production of film are performed in the same manner as in Example 1 except that in Example 3, the additive is changed to polystyrene (#379514, produced by Aldrich, weight average molecular weight Mw: about 14,000). The evaluation results of the film obtained are shown in Table 1.

### Example 24

A cyclic olefin-based resin film is obtained in the same manner as in Example 1 except that in Example 23, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 25

Preparation of Dope D-13 and production of film are performed in the same manner as in Example 1 except that in Example 1, the additive is changed to a poly(styrene-methacrylate) copolymer (#462896, produced by Aldrich, weight average molecular weight Mw: about 130,000, styrene/methacrylate=40/60). The evaluation results of the film obtained are shown in Table 1.

### Example 26

A cyclic olefin-based resin film is obtained in the same manner as in Example 1 except that in Example 25, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 27

Preparation of Dope D-14 and production of film are performed in the same manner as in Example 1 except that in Example 3, the additive is changed to a poly(styrene-maleic anhydride) copolymer (#426954, produced by Aldrich, weight average molecular weight Mw: about 180,000, styrene/maleic anhydride=86/14). The evaluation results of the film obtained are shown in Table 1.

### Example 28

A cyclic olefin-based resin film is obtained in the same manner as in Example 1 except that in Example 27, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 29

Preparation of Dope D-15 and production of film are performed in the same manner as in Example 1 except that in Example 3, the additive is changed to “ARUFON UH-2041” (weight average molecular weight Mw: about 2,500) produced by Toagosei Co., Ltd. The evaluation results of the film obtained are shown in Table 1.

### Example 30

A cyclic olefin-based resin film is obtained in the same manner as in Example 1 except that in Example 29, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 31

A cyclic olefin-based resin film is obtained in the same manner as in Example 1 except that in Example 29, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 32

Preparation of Dope D-16 and production of film are performed in the same manner as in Example 1 except that in Example 29, the amount of the additive added is changed to 30 parts by mass. The evaluation results of the film obtained are shown in Table 1.

### Example 33

A cyclic olefin-based resin film is obtained in the same manner as in Example 1 except that in Example 32, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 34

A cyclic olefin-based resin film is obtained in the same manner as in Example 1 except that in Example 32, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 35

Preparation of Dope D-17 and production of film are performed in the same manner as in Example 1 except that in Example 5, the additive is changed to a poly(styrene-maleic anhydride) copolymer partially with propyl ester (#442356, produced by Aldrich). The evaluation results of the film obtained are shown in Table 1.

### Example 36

A cyclic olefin-based resin film is obtained in the same manner as in Example 1 except that in Example 35, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 37

Preparation of Dope D-18 and production of film are performed in the same manner as in Example 1 except that in Example 5, the additive is changed to “ACTFLOW CBB3098” (weight average molecular weight Mw: about 2,000) produced by The Soken Chemical & Engineering Co., Ltd. The evaluation results of the film obtained are shown in Table 1.

### Example 38

A cyclic olefin-based resin film is obtained in the same manner as in Example 1 except that in Example 37, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 39

Preparation of Dope D-19 and production of film are performed in the same manner as in Example 1 except that in Example 5, the additive is changed to “ACTFLOW CB3098” (weight average molecular weight Mw: about 2,000) produced by The Soken Chemical & Engineering Co., Ltd. The evaluation results of the film obtained are shown in Table 1.

### Example 40

A cyclic olefin-based resin film is obtained in the same manner as in Example 1 except that in Example 39, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 41

Preparation of Dope D-20 and production of film are performed in the same manner as in Example 1 except that in Example 5, the additive is changed to “ACTFLOW AS301” (weight average molecular weight Mw: about 1,300) produced by The Soken Chemical & Engineering Co., Ltd. The evaluation results of the film obtained are shown in Table 1.

### Example 42

A cyclic olefin-based resin film is obtained in the same manner as in Example 1 except that in Example 41, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21 ADH (manufactured by Oji Test Instruments).

### Example 43

Preparation of Dope D-21 and production of film are performed in the same manner as in Example 1 except that in Example 5, the additive is changed to “ACTFLOW UME2005” (weight average molecular weight Mw: about 3,500) produced by The Soken Chemical & Engineering Co., Ltd. The evaluation results of the film obtained are shown in Table 1.

### Example 44

A cyclic olefin-based resin film is obtained in the same manner as in Example 1 except that in Example 43, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 45

Preparation of Dope D-22 and production of film are performed in the same manner as in Example 1 except that in Example 5, the additive is changed to “EXRON V-120” (weight average molecular weight Mw: about 730) produced by Nippon Steel Chemical Co., Ltd. The evaluation results of the film obtained are shown in Table 1.

### Example 46

A cyclic olefin-based resin film is obtained in the same manner as in Example 1 except that in Example 45, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 47

Preparation of Dope D-23 and production of film are performed in the same manner as in Example 1 except that in Example 5, the additive is changed to “GSM301” (weight average molecular weight Mw: about 2,300) produced by Gifu Shellac Mfg., Co., Ltd. The evaluation results of the film obtained are shown in Table 1.

### Example 48

A cyclic olefin-based resin film is obtained in the same manner as in Example 1 except that in Example 47, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 49

Preparation of Dope D-24 and production of film are performed in the same manner as in Example 1 except that in Example 5, the additive is changed to “Joncryl 586” (weight average molecular weight Mw: about 4,600) produced by BASF. The evaluation results of the film obtained are shown in Table 1.

### Example 50

A cyclic olefin-based resin film is obtained in the same manner as in Example 1 except that in Example 49, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 51

Preparation of Dope D-25 and production of film are performed in the same manner as in Example 1 except that in Example 3, the additive is changed to “ARUFON UH-2180” (weight average molecular weight Mw: about 8,000) produced by Toagosei Co., Ltd. The evaluation results of the film obtained are shown in Table 1.

### Example 52

A cyclic olefin-based resin film is obtained in the same manner as in Example 1 except that in Example 51, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 53

Preparation of Dope D-26 and production of film are performed in the same manner as in Example 1 except that in Example 5, the additive is changed to “ARUFON UH-2180” (weight average molecular weight Mw: about 8,000) produced by Toagosei Co., Ltd. The evaluation results of the film obtained are shown in Table 1.

### Example 54

A cyclic olefin-based resin film is obtained in the same manner as in Example 1 except that in Example 53, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 55

Preparation of Dope D-27 and production of film are performed in the same manner as in Example 1 except that in Example 7, the additive is changed to “ARUFON UH-2180” (weight average molecular weight Mw: about 8,000) produced by Toagosei Co., Ltd. The evaluation results of the film obtained are shown in Table 1.

### Example 56

A cyclic olefin-based resin film is obtained in the same manner as in Example 1 except that in Example 55, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 57

Preparation of Dope D-28 and production of film are performed in the same manner as in Example 1 except that in Example 9, the additive is changed to “ARUFON UH-2180” (weight average molecular weight Mw: about 8,000) produced by Toagosei Co., Ltd. The evaluation results of the film obtained are shown in Table 1.

### Example 58

A cyclic olefin-based resin film is obtained in the same manner as in Example 1 except that in Example 57, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 59

(Polyolefin Dope D-29)

| | |
|---|---|
| Cyclic Polyolefin Polymer P-1 | 150 parts by mass |
| Additive 1: “ARUFON UH-2041”, produced | 15 parts by mass |
| by Toagosei Co., Ltd. (weight average | |
| molecular weight Mw: about 2,500) | |
| Additive 2: “ARUFON UH-2180”, produced | 15 parts by mass |
| by Toagosei Co., Ltd. (weight average | |
| molecular weight Mw: about 8,000) | |
| Deterioration inhibitor: “IRGANOX 1010” | 0.45 parts by mass |
| produced by Ciba Specialty Chemicals | |
| Dichloromethane | 620 parts by mass |

The composition above is charged into a mixing tank and stirred to dissolve respective components, and the resulting solution is filtered through filter paper having an average pore size of 34 μm and further through a sintered metal filter having an average pore size of 10 μm to prepare Cyclic Polyolefin Dope D-29. The dope is cast by a band casting machine and when the residual solvent amount is about 30 mass %, the film is separated from the band and dried by blowing hot air at 140° C. in a tenter. Thereafter, the conveyance is transferred to roll conveyance from tenter conveyance, and the film is further dried at 120 to 140° C. and then taken up. At this time, the film thickness is 80 μm. The Re retardation and Rth retardation of the produced film are measured by KOBRA 21ADH (manufactured by Oji Test Instruments).

### Example 60

A cyclic olefin-based resin film is obtained in the same manner as in Example 1 except that in Example 59, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 61

Preparation of Dope D-30 and production of film are performed in the same manner as in Example 1 except that in Example 59, the amount of the additive 1 added is changed to 22.5 parts by mass and the amount of the additive 2 added is changed to 22.5 parts by mass. The evaluation results of the film obtained are shown in Table 1.

### Example 62

A cyclic olefin-based resin film is obtained in the same manner as in Example 1 except that in Example 61, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 63

Preparation of Dope D-31 and production of film are performed in the same manner as in Example 1 except that in Example 59, the amount of the additive 1 added is changed to 9 parts by mass and the amount of the additive 2 added is changed to 21 parts by mass. The evaluation results of the film obtained are shown in Table 1.

### Example 64

A cyclic olefin-based resin film is obtained in the same manner as in Example 1 except that in Example 63, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 65

Preparation of Dope D-32 and production of film are performed in the same manner as in Example 1 except that in Example 59, the amount of the additive 1 added is changed to 13.5 parts by mass and the amount of the additive 2 added is changed to 31.5 parts by mass. The evaluation results of the film obtained are shown in Table 1.

### Example 66

A cyclic olefin-based resin film is obtained in the same manner as in Example 1 except that in Example 65, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 67

Preparation of Dope D-33 and production of film are performed in the same manner as in Example 1 except that in Example 59, the additive 1 is changed “ACTFLOW CBB3098” (weight average molecular weight Mw: about 2,000) produced by The Soken Chemical & Engineering Co., Ltd. The evaluation results of the film obtained are shown in Table 1.

### Example 68

A cyclic olefin-based resin film is obtained in the same manner as in Example 1 except that in Example 67, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 69

Preparation of Dope D-34 and production of film are performed in the same manner as in Example 1 except that in Example 67, the amount of the additive 1 added is changed to 22.5 parts by mass and the amount of the additive 2 added is changed to 22.5 parts by mass. The evaluation results of the film obtained are shown in Table 1.

### Example 70

A cyclic olefin-based resin film is obtained in the same manner as in Example 1 except that in Example 69, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 71

Preparation of Dope D-35 and production of film are performed in the same manner as in Example 1 except that in Example 67, the amount of the additive 1 added is changed to 9 parts by mass and the amount of the additive 2 added is changed to 21 parts by mass. The evaluation results of the film obtained are shown in Table 1.

### Example 72

A cyclic olefin-based resin film is obtained in the same manner as in Example 1 except that in Example 71, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Example 73

Preparation of Dope D-36 and production of film are performed in the same manner as in Example 1 except that in Example 67, the amount of the additive 1 added is changed to 13.5 parts by mass and the amount of the additive 2 added is changed to 31.5 parts by mass. The evaluation results of the film obtained are shown in Table 1.

### Example 74

A cyclic olefin-based resin film is obtained in the same manner as in Example 1 except that in Example 73, the film is widthwise stretched to a stretch ratio of 24% by using a tenter and then relaxed at 140° C. for 60 seconds to reduce the stretch ratio to 20%. At this time, the film thickness is 80 μm. The Re retardation and Rth retardation of the produced film are measured by KOBRA 21ADH (manufactured by Oji Test Instruments).

### Comparative Example 1

Preparation of Dope D-37 and production of film are performed in the same manner as in Example 1 except that in Example 1, the amount of the additive added is changed to 0 mass %. The evaluation results of the film obtained are shown in Table 1.

### Comparative Example 2

A cyclic olefin-based resin film is obtained in the same manner as in Example 1 except that in Comparative Example 1, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 75

Preparation of Dope D-38 and production of film are performed in the same manner as in Example 1 except that in Example 1, the amount of the additive added is changed to 67.5 parts by mass. The evaluation results of the film obtained are shown in Table 1.

### Example 76

Preparation of Dope D-39 and production of film are performed in the same manner as in Example 1 except that in Example 3, the additive is changed to poly(methyl methacrylate) (#445746, produced by Aldrich, weight average molecular weight Mw: about 350,000). The evaluation results of the film obtained are shown in Table 1.

### Example 77

(Polyolefin Dope D-40)

| | |
|---|---|
| ARTON G (produced by JSR) | 150 parts by mass |
| Additive: polymethyl acrylate (“ACTFLOW | 15 parts by mass |
| UMM1001”, produced by The Soken Chemical | |
| & Engineering Co., Ltd., weight average | |
| molecular weight Mw: about 1,000) | |
| Deterioration inhibitor: “IRGANOX 1010” | 0.45 parts by mass |
| produced by Ciba Specialty Chemicals | |
| Dichloromethane | 620 parts by mass |

The composition above is charged into a mixing tank and stirred to dissolve respective components, whereby Dope D-40 containing a retardation decreasing agent is prepared. Thereafter, a cyclic polyolefin film is produced in the same manner as in Example 1. The evaluation results are shown in Table 1.

### Example 78

Preparation of Dope D-41 and production of film are performed in the same manner as in Example 1 except that in Example 77, the additive is changed to polystyrene (#327824, produced by Aldrich, weight average molecular weight Mw: about 800). The evaluation results of the film obtained are shown in Table 1.

### Comparative Example 3

Preparation of Dope D-42 and production of film are performed in the same manner as in Example 1 except that in Example 77, the amount of the additive added is changed to 0 mass %. The evaluation results of the film obtained are shown in Table 1.

### Example 79

(Polyolefin Composition D-43)

| | |
|---|---|
| ZEONOR (produced by ZEON Corp.) | 150 parts by mass |
| Additive: polymethyl acrylate (“ACTFLOW | 15 parts by mass |
| UMM1001”, produced by The Soken | |
| Chemical & Engineering Co., Ltd., | |
| weight average molecular weight | |
| Mw: about 1,000) | |

The composition above is cast using a T-die type film melt-extruding machine having a resin melt-kneader equipped with a 65 mmφ screw under molding conditions of a molten resin temperature of 240° C. and a width of T-die of 350 mm. At this time, the film thickness is 80 μm. The Re retardation and Rth retardation of the produced film are measured by KOBRA 21ADH (manufactured by Oji Test Instruments).

### Example 80

The film obtained in Example 79 is monoaxially stretched with free width (stretch ratio: 1.1 times) at 155° C. to obtain a cyclic olefin-based film. At this time, the film thickness is 80 μm. The Re retardation and Rth retardation of the produced film are measured by KOBRA 21ADH (manufactured by Oji Test Instruments).

### Example 81

Preparation of Dope D-44 and production of film are performed in the same manner as in Example 79 except that in Example 79, the additive is changed to polystyrene (#327824, produced by Aldrich, weight average molecular weight Mw: about 800). The evaluation results of the film obtained are shown in Table 1.

### Example 82

The film obtained in Example 80 is monoaxially stretched with free width (stretch ratio: 1.1 times) at 155° C. to obtain a cyclic olefin-based film. At this time, the film thickness is 80 μm. The Re retardation and Rth retardation of the produced film are measured by KOBRA 21ADH (manufactured by Oji Test Instruments).

### Comparative Example 4

Preparation of Dope D-45 and production of film are performed in the same manner as in Example 79 except that in Example 79, the amount of the additive added is changed to 0 mass %. The evaluation results of the film obtained are shown in Table 1.

### Comparative Example 5

The film obtained in Comparative Example 4 is monoaxially stretched with free width (stretch ratio: 1.1 times) at 155° C. to obtain a cyclic olefin-based film. At this time, the film thickness is 80 μm. The Re retardation and Rth retardation of the produced film are measured by KOBRA 21ADH (manufactured by Oji Test Instruments).

### Example 83

(Polyolefin Dope D-46)

| | |
|---|---|
| Appear3000 (produced by Ferrania) | 150 parts by mass |
| Additive: polymethyl acrylate (“ACTFLOW | 15 parts by mass |
| UMM1001”, produced by The Soken Chemical | |
| & Engineering Co., Ltd., weight average | |
| molecular weight Mw: about 1,000) | |
| Deterioration inhibitor: “IRGANOX 1010” | 0.45 parts by mass |
| produced by Ciba Specialty Chemicals | |
| Dichloromethane | 620 parts by mass |

The composition above is charged into a mixing tank and stirred to dissolve respective components, whereby Dope D-46 containing a retardation decreasing agent is prepared. Thereafter, a cyclic polyolefin film is produced in the same manner as in Example 1. The evaluation results are shown in Table 1.

### Example 84

A cyclic olefin-based resin film is obtained in the same manner as in Example 1 except that in Example 83, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Example 85

Preparation of Dope D-47 and production of film are performed in the same manner as in Example 1 except that in Example 83, the additive is changed to polystyrene (#327824, produced by Aldrich, weight average molecular weight Mw: about 800). The evaluation results of the film obtained are shown in Table 1.

### Example 86

A cyclic olefin-based resin film is obtained in the same manner as in Example 1 except that in Example 85, the film is widthwise stretched to a stretch ratio of 12% by using a tenter and then relaxed at 140° C. for 60 seconds to reduce the stretch ratio to 10%. At this time, the film thickness is 80 μm. The Re retardation and Rth retardation of the produced film are measured by KOBRA 21ADH (manufactured by Oji Test Instruments).

### Comparative Example 6

Preparation of Dope D-48 and production of film are performed in the same manner as in Example 1 except that in Example 83, the amount of the additive added is changed to 0 mass %. The evaluation results of the film obtained are shown in Table 1.

### Comparative Example 7

Preparation of Dope D-49 and production of film are performed in the same manner as in Example 1 except that in Example 3, the additive is changed to “Polyvinylpyrrolidone K-15” (weight average molecular weight Mw: about 10,000) produced by Tokyo Kasei Kogyo Co., Ltd. The evaluation results of the film obtained are shown in Table 1.

### Examples 87 to 94

By using the same dope as that in Example 3, production of each film is performed at the film thickness and stretch ratio as shown in Table 2. The evaluation results of each film obtained are shown in Table 2.

### Comparative Examples 8 to 15

Preparation of dope is performed in the same manner as in Example 1 except that in Example 3, the amount of the additive added is changed to 0 mass %, and films differing in the thickness are produced. The evaluation results of each film obtained are shown in Table 2. In Tables 1 and 2, PMMA denotes polymethyl methacrylate, PSt denotes polystyrene, SMA denotes a (styrene-maleic anhydride) copolymer, SMA(2) denotes a (styrene-maleic anhydride) copolymer partially with propyl ester, and PVP denotes polyvinylpyrrolidone.

### Example 95

### (Production of Polarizing Plate)

A polarizer is produced by adsorbing iodine to a stretched polyvinyl alcohol film.

The cyclic olefin-based resin film (F-4) produced in Example 4 is subjected to a glow discharge treatment (treatment for 20 seconds by applying a high-frequency voltage of 4,200 V at a frequency of 3,000 Hz between upper and lower electrodes) and then laminated to one side of the polarizer as follows by using a polyvinyl alcohol-based adhesive. Furthermore, a commercially available cellulose triacylate film (FUJI-TAC TD80UF, produced by Fujifilm Corp.) is saponified, then laminated to the opposite side of the polarizer by using a polyvinyl alcohol-based adhesive, and dried at 70° C. for 10 minutes or more, whereby Polarizing Plate A is produced.

The transmission axis of the polarizing film and the slow axis of the cyclic olefin-based resin film (F-4) are arranged to run in parallel. Also, the transmission axis of the polarizing film and the slow axis of the commercially available cellulose triacylate film are arranged to cross at right angles.

### (Production of VA Liquid Crystal Cell)

The liquid crystal cell is produced by setting the cell gap between substrates to 3.6 μm, injecting dropwise a liquid crystal material (“MLC6608”, produced by Merck Ltd.) with negative dielectric anisotropy between the substrates, and encapsulating it to form a liquid crystal layer between the substrates. The retardation of the liquid crystal layer (that is, a product Δn·d of the thickness d (μm) and the refractive index anisotropy Δn of the liquid crystal layer) is set to 300 nm. Incidentally, the liquid crystal material is oriented in the vertical alignment. A commercially available superhigh contrast product (HLC2-5618, manufactured by Sanritz Corp.) is laminated to the upper side (viewer side) of the vertically aligned liquid crystal cell through a pressure-sensitive adhesive, and Polarizing Plate A produced above is laminated to the lower side (backlight side) of the liquid crystal cell through a pressure-sensitive adhesive. At this time, a cross-Nicol arrangement is employed such that the transmission axis of the upper polarizing plate runs in the vertical direction and the transmission axis of the lower polarizing plate runs in the horizontal direction.

The produced liquid crystal display device is observed, as a result, it is found that a neutral black display can be realized in both the front direction and the viewing angle direction. Also, the viewing angle (the range where the contrast ratio is 10 or more and the black side is free from tone reversal) is measured in 8 steps from black display (L1) to white display (L8) by using a measuring apparatus (EZ-Contrast 160D, manufactured by ELDIM), as a result, good viewing angle of 80° or more is obtained on both right and left sides.

### Example 96

### (Production of Polarizing Plate)

A polarizer is produced by adsorbing iodine to a stretched polyvinyl alcohol film.

The cyclic olefin-based resin film (F-8) produced in Example 8 is subjected to a glow discharge treatment (treatment for 20 seconds by applying a high-frequency voltage of 4,200 V at a frequency of 3,000 Hz between upper and lower electrodes) and then laminated to one side of the polarizer as follows by using a polyvinyl alcohol-based adhesive. Furthermore, a commercially available cellulose triacylate film (FUJI-TAC TD80UF, produced by Fujifilm Corp.) is saponified, then laminated to the opposite side of the polarizer by using a polyvinyl alcohol-based adhesive, and dried at 70° C. for 10 minutes or more, whereby Polarizing Plate B is produced.

The transmission axis of the polarizing film and the slow axis of the cyclic olefin-based resin film (F-8) are arranged to run in parallel. Also, the transmission axis of the polarizing film and the slow axis of the commercially available cellulose triacylate film are arranged to cross at right angles.

### (Production of VA Liquid Crystal Cell)

The liquid crystal cell is produced by setting the cell gap between substrates to 3.6 μm, injecting dropwise a liquid crystal material (“MLC6608”, produced by Merck Ltd.) with negative dielectric anisotropy between the substrates, and encapsulating it to form a liquid crystal layer between the substrates. The retardation of the liquid crystal layer (that is, a product Δn·d of the thickness d (μm) and the refractive index anisotropy Δn of the liquid crystal layer) is set to 300 nm. Incidentally, the liquid crystal material is oriented in the vertical alignment. Polarizing Plate B produced above is laminated to both the upper side (viewer side) and the lower side (backlight side) of the vertically aligned liquid crystal cell through a pressure-sensitive adhesive. At this time, a cross-Nicol arrangement is employed such that the transmission axis of the upper polarizing plate runs in the vertical direction and the transmission axis of the lower polarizing plate runs in the horizontal direction.

The produced liquid crystal display device is observed, as a result, it is found that a neutral black display can be realized in both the front direction and the viewing angle direction. Also, the viewing angle (the range where the contrast ratio is 10 or more and the black side is free from tone reversal) is measured in 8 steps from black display (L1) to white display (L8) by using a measuring apparatus (EZ-Contrast 160D, manufactured by ELDIM), as a result, good viewing angle of 80° or more is obtained on both right and left sides.

TABLE 1

| | | | | | Added | | | | | | |
|---|---|---|---|---|---|---|---|---|---|---|---|
| | | | Weight | | Amount | | | | | | |
| | Cyclic | | Average | \|σ(A) − | A % | Film- | | | | Rth(A) − | |
| | Polyolefin | | Molecular | σ(P)\| | vs. Cyclic | Forming | Stretch | Re | Rth | Rth(0)/A | |
| | Resin | Additive | Weight | (MPa)^{1/2} | Olefin | Method | ratio % | nm | nm | nm/% | Haze |
| Comparative | P-1 | none | — | — | 0 | solution | unstretched | 8 | 276 | — | 0.3 |
| Example 1 | | | | | | casting | | | | | |
| Comparative | P-1 | none | — | — | 0 | solution | 10 | 110 | 310 | — | 0.3 |
| Example 2 | | | | | | casting | | | | | |
| Example 1 | P-1 | UMM1001 | 1000 | 0.95 | 5 | solution | unstretched | 31 | 248 | −5.6 | 0.3 |
| | | | | | | casting | | | | | |
| Example 2 | P-1 | UMM1001 | 1000 | 0.95 | 5 | solution | 10 | 80 | 288 | −4.4 | 0.3 |
| | | | | | | casting | | | | | |
| Example 3 | P-1 | UMM1001 | 1000 | 0.95 | 10 | solution | unstretched | 6 | 201 | −7.5 | 0.1 |
| | | | | | | casting | | | | | |
| Example 4 | P-1 | UMM1001 | 1000 | 0.95 | 10 | solution | 10 | 60 | 212 | −9.8 | 0.1 |
| | | | | | | casting | | | | | |
| Example 5 | P-1 | UMM1001 | 1000 | 0.95 | 20 | solution | unstretched | 25 | 140 | −6.8 | 0.1 |
| | | | | | | casting | | | | | |
| Example 6 | P-1 | UMM1001 | 1000 | 0.95 | 20 | solution | 10 | 60 | 173 | −6.8 | 0.1 |
| | | | | | | casting | | | | | |
| Example 7 | P-1 | UMM1001 | 1000 | 0.95 | 30 | solution | unstretched | 24 | 100 | −5.9 | 0.5 |
| | | | | | | casting | | | | | |
| Example 8 | P-1 | UMM1001 | 1000 | 0.95 | 30 | solution | 10 | 48 | 105 | −6.8 | 0.5 |
| | | | | | | casting | | | | | |
| Example 9 | P-1 | UMM1001 | 1000 | 0.95 | 40 | solution | unstretched | 9 | 72 | −5.1 | 0.9 |
| | | | | | | casting | | | | | |
| Example 10 | P-1 | UMM1001 | 1000 | 0.95 | 40 | solution | 10 | 42 | 62 | −6.2 | 0.9 |
| | | | | | | casting | | | | | |
| Example 11 | P-1 | UP-1010 | 1700 | 0.15 | 10 | solution | unstretched | 35 | 216 | −6.0 | 0.2 |
| | | | | | | casting | | | | | |
| Example 12 | P-1 | UP-1010 | 1700 | 0.15 | 10 | solution | 10 | 69 | 228 | −8.2 | 0.2 |
| | | | | | | casting | | | | | |
| Example 13 | P-1 | PMMA | 10000 | 1.08 | 10 | solution | unstretched | 10 | 219 | −5.7 | 0.8 |
| | | | | | | casting | | | | | |
| Example 14 | P-1 | PMMA | 10000 | 1.08 | 10 | solution | 10 | 60 | 240 | −7.0 | 0.8 |
| | | | | | | casting | | | | | |
| Example 15 | P-1 | PSt | 800 | 0.91 | 5 | solution | unstretched | 28 | 234 | −8.4 | 0.3 |
| | | | | | | casting | | | | | |
| Example 16 | P-1 | PSt | 800 | 0.91 | 5 | solution | 10 | 75 | 286 | −4.8 | 0.3 |
| | | | | | | casting | | | | | |
| Example 17 | P-1 | PSt | 800 | 0.91 | 10 | solution | unstretched | 34 | 173 | −10.3 | 0.16 |
| | | | | | | casting | | | | | |
| Example 18 | P-1 | PSt | 800 | 0.91 | 10 | solution | 10 | 80 | 202 | −10.8 | 0.16 |
| | | | | | | casting | | | | | |
| Example 19 | P-1 | PSt | 2500 | 0.91 | 3 | solution | unstretched | 24 | 261 | −5.1 | 0.3 |
| | | | | | | casting | | | | | |
| Example 20 | P-1 | PSt | 2500 | 0.91 | 3 | solution | 10 | 88 | 280 | −10.0 | 0.3 |
| | | | | | | casting | | | | | |
| Example 21 | P-1 | PSt | 2500 | 0.91 | 10 | solution | unstretched | 21 | 204 | −7.3 | 0.2 |
| | | | | | | casting | | | | | |
| Example 22 | P-1 | PSt | 2500 | 0.91 | 10 | solution | 10 | 80 | 242 | −6.8 | 0.2 |
| | | | | | | casting | | | | | |
| Example 23 | P-1 | PSt | 14000 | 0.91 | 10 | solution | unstretched | 34 | 215 | −6.1 | 13 |
| | | | | | | casting | | | | | |
| Example 24 | P-1 | PSt | 14000 | 0.91 | 10 | solution | 10 | 94 | 241 | −6.9 | 13.1 |
| | | | | | | casting | | | | | |
| Example 25 | P-1 | PSt-PMMA | 130000 | 1.01 | 5 | solution | unstretched | 27 | 260 | −3.2 | 0.9 |
| | | | | | | casting | | | | | |
| Example 26 | P-1 | PSt-PMMA | 130000 | 1.01 | 5 | solution | 10 | 91 | 298 | −2.4 | 0.9 |
| | | | | | | casting | | | | | |
| Example 27 | P-1 | SMA | 180000 | 0.18 | 10 | solution | unstretched | 35 | 222 | −5.4 | 0.2 |
| | | | | | | casting | | | | | |
| Example 28 | P-1 | SMA | 180000 | 0.18 | 10 | solution | 10 | 90 | 244 | −6.6 | 0.2 |
| | | | | | | casting | | | | | |
| Example 29 | P-1 | UH-2041 | 2500 | 0.1 | 10 | solution | unstretched | 6 | 201 | −10.9 | 0.2 |
| | | | | | | casting | | | | | |
| Example 30 | P-1 | UH-2041 | 2500 | 0.1 | 10 | solution | 10 | 40 | 212 | −9.8 | 0.2 |
| | | | | | | casting | | | | | |
| Example 31 | P-1 | UH-2041 | 2500 | 0.1 | 10 | solution | 20 | 92 | 223 | −8.7 | 0.3 |
| | | | | | | casting | | | | | |
| Example 32 | P-1 | UH-2041 | 2500 | 0.1 | 20 | solution | unstretched | 4 | 132 | −8.9 | 0.2 |
| | | | | | | casting | | | | | |
| Example 33 | P-1 | UH-2041 | 2500 | 0.1 | 20 | solution | 10 | 30 | 145 | −8.3 | 0.2 |
| | | | | | | casting | | | | | |
| Example 34 | P-1 | UH-2041 | 2500 | 0.1 | 20 | solution | 20 | 66 | 160 | −7.5 | 0.3 |
| | | | | | | casting | | | | | |
| Example 35 | P-1 | SMA(2) | 1900 | 0.18 | 20 | solution | unstretched | 5 | 120 | −9.5 | 0.2 |
| | | | | | | casting | | | | | |
| Example 36 | P-1 | SMA(2) | 1900 | 0.18 | 20 | solution | 20 | 59 | 160 | −7.5 | 0.2 |
| | | | | | | casting | | | | | |
| Example 37 | P-1 | CBB3098 | 2000 | 0.56 | 20 | solution | unstretched | 11 | 114 | −9.8 | 0.2 |
| | | | | | | casting | | | | | |
| Example 38 | P-1 | CBB3098 | 2000 | 0.56 | 20 | solution | 20 | 71 | 144 | −8.3 | 0.2 |
| | | | | | | casting | | | | | |
| Example 39 | P-1 | CB3098 | 2000 | 0.98 | 20 | solution | unstretched | 6 | 105 | −10.3 | 0.3 |
| | | | | | | casting | | | | | |
| Example 40 | P-1 | CB3098 | 2000 | 0.98 | 20 | solution | 20 | 62 | 150 | −8.0 | 0.2 |
| | | | | | | casting | | | | | |
| Example 41 | P-1 | AS301 | 1300 | — | 20 | solution | unstretched | 7 | 120 | −9.5 | 0.2 |
| | | | | | | casting | | | | | |
| Example 42 | P-1 | AS301 | 1300 | — | 20 | solution | 20 | 58 | 150 | −8.0 | 0.1 |
| | | | | | | casting | | | | | |
| Example 43 | P-1 | UME2005 | 3500 | 0.2 | 20 | solution | unstretched | 13 | 121 | −9.5 | 0.3 |
| | | | | | | casting | | | | | |
| Example 44 | P-1 | UME2005 | 3500 | 0.2 | 20 | solution | 20 | 60 | 149 | −8.1 | 0.2 |
| | | | | | | casting | | | | | |
| Example 45 | P-1 | V-120 | 730 | — | 20 | solution | unstretched | 15 | 115 | −9.8 | 0.2 |
| | | | | | | casting | | | | | |
| Example 46 | P-1 | V-120 | 730 | — | 20 | solution | 20 | 68 | 170 | −7.0 | 0.2 |
| | | | | | | casting | | | | | |
| Example 47 | P-1 | GSM301 | 2300 | 2.13 | 20 | solution | unstretched | 11 | 145 | −8.3 | 0.2 |
| | | | | | | casting | | | | | |
| Example 48 | P-1 | GSM301 | 2300 | 2.13 | 20 | solution | 20 | 56 | 156 | −7.7 | 0.2 |
| | | | | | | casting | | | | | |
| Example 49 | P-1 | Johnson Polymer | 4600 | 0.68 | 20 | solution | unstretched | 10 | 145 | −8.3 | 0.2 |
| | | 586 | | | | casting | | | | | |
| Example 50 | P-1 | Johnson Polymer | 4600 | 0.68 | 20 | solution | 20 | 52 | 152 | −7.9 | 0.3 |
| | | 586 | | | | casting | | | | | |
| Example 51 | P-1 | UH-2180 | 8000 | 0.41 | 10 | solution | unstretched | 6 | 203 | −10.7 | 0.1 |
| | | | | | | casting | | | | | |
| Example 52 | P-1 | UH-2180 | 8000 | 0.41 | 10 | solution | 20 | 66 | 215 | −9.5 | 0.1 |
| | | | | | | casting | | | | | |
| Example 53 | P-1 | UH-2180 | 8000 | 0.41 | 20 | solution | unstretched | 12 | 145 | −8.3 | 0.1 |
| | | | | | | casting | | | | | |
| Example 54 | P-1 | UH-2180 | 8000 | 0.41 | 20 | solution | 20 | 65 | 156 | −7.7 | 0.1 |
| | | | | | | casting | | | | | |
| Example 55 | P-1 | UH-2180 | 8000 | 0.41 | 30 | solution | unstretched | 18 | 108 | −6.7 | 0.2 |
| | | | | | | casting | | | | | |
| Example 56 | P-1 | UH-2180 | 8000 | 0.41 | 30 | solution | 20 | 50 | 112 | −6.6 | 0.1 |
| | | | | | | casting | | | | | |
| Example 57 | P-1 | UH-2180 | 8000 | 0.41 | 40 | solution | unstretched | 11 | 75 | −5.9 | 0.2 |
| | | | | | | casting | | | | | |
| Example 58 | P-1 | UH-2180 | 8000 | 0.41 | 40 | solution | 20 | 46 | 80 | −5.8 | 0.2 |
| | | | | | | casting | | | | | |
| Example 59 | P-1 | UH-2041/UH-2180 = 5/5 | — | — | 20 | solution | unstretched | 10 | 132 | −8.9 | 0.1 |
| | | | | | | casting | | | | | |
| Example 60 | P-1 | UH-2041/UH-2180 = 5/5 | — | — | 20 | solution | 20 | 55 | 150 | −8.0 | 0.1 |
| | | | | | | casting | | | | | |
| Example 61 | P-1 | UH-2041/UH-2180 = 5/5 | — | — | 30 | solution | unstretched | 12 | 107 | −6.8 | 0.2 |
| | | | | | | casting | | | | | |
| Example 62 | P-1 | UH-2041/UH-2180 = 5/5 | — | — | 30 | solution | 20 | 51 | 120 | −6.3 | 0.2 |
| | | | | | | casting | | | | | |
| Example 63 | P-1 | UH-2041/UH-2180 = 3/7 | — | — | 20 | solution | unstretched | 11 | 142 | −8.4 | 0.1 |
| | | | | | | casting | | | | | |
| Example 64 | P-1 | UH-2041/UH-2180 = 3/7 | — | — | 20 | solution | 20 | 65 | 160 | −7.5 | 0.1 |
| | | | | | | casting | | | | | |
| Example 65 | P-1 | UH-2041/UH-2180 = 3/7 | — | — | 30 | solution | unstretched | 16 | 110 | −6.7 | 0.2 |
| | | | | | | casting | | | | | |
| Example 66 | P-1 | UH-2041/UH-2180 = 3/7 | — | — | 30 | solution | 20 | 52 | 122 | −6.3 | 0.2 |
| | | | | | | casting | | | | | |
| Example 67 | P-1 | CBB3098/UH-2180 = 5/5 | — | — | 30 | solution | unstretched | 11 | 122 | −6.3 | 0.2 |
| | | | | | | casting | | | | | |
| Example 68 | P-1 | CBB3098/UH-2180 = 5/5 | — | — | 20 | solution | 20 | 58 | 160 | −7.5 | 0.1 |
| | | | | | | casting | | | | | |
| Example 69 | P-1 | CBB3098/UH-2180 = 5/5 | — | — | 30 | solution | unstretched | 10 | 110 | −6.7 | 0.2 |
| | | | | | | casting | | | | | |
| Example 70 | P-1 | CBB3098/UH-2180 = 5/5 | — | — | 30 | solution | 20 | 51 | 122 | −6.3 | 0.2 |
| | | | | | | casting | | | | | |
| Example 71 | P-1 | UH-2041/GSM301 = 5/5 | — | — | 30 | solution | unstretched | 8 | 122 | −6.3 | 0.2 |
| | | | | | | casting | | | | | |
| Example 72 | P-1 | UH-2041/GSM301 = 5/5 | — | — | 20 | solution | 20 | 46 | 160 | −7.5 | 0.1 |
| | | | | | | casting | | | | | |
| Example 73 | P-1 | UH-2041/GSM301 = 5/5 | — | — | 30 | solution | unstretched | 7 | 110 | −6.7 | 0.2 |
| | | | | | | casting | | | | | |
| Example 74 | P-1 | UH-2041/GSM301 = 5/5 | — | — | 30 | solution | 20 | 42 | 122 | −6.3 | 0.2 |
| | | | | | | casting | | | | | |
| Example 75 | P-1 | UMM1001 | 1000 | 0.95 | 45 | solution | unstretched | 4 | 108 | −6.7 | 0.2 |
| | | | | | | casting | | | | | |
| Example 76 | P-1 | PMMA | 350000 | 1.08 | 10 | solution | unstretched | 21 | 112 | −6.6 | 0.1 |
| | | | | | | casting | | | | | |
| Comparative | ARTON | none | — | — | — | solution | unstretched | 1 | 15 | — | 0.2 |
| Example 3 | | | | | | casting | | | | | |
| Example 77 | ARTON | UMM1001 | 2500 | 1.64 | 10 | solution | unstretched | 0 | −10 | −2.5 | 0.3 |
| | | | | | | casting | | | | | |
| Example 78 | ARTON | PSt | 800 | 0.22 | 10 | solution | unstretched | 1 | −12 | −2.7 | 0.3 |
| | | | | | | casting | | | | | |
| Comparative | ZEONOR | none | — | — | — | fusion | unstretched | 6 | 10 | — | 0.2 |
| Example 4 | | | | | | casting | | | | | |
| Comparative | ZEONOR | none | — | — | — | fusion | 10 | 55 | 60 | — | 0.2 |
| Example 5 | | | | | | casting | | | | | |
| Example 79 | ZEONOR | UMM1001 | 1000 | 2.5 | 10 | fusion | unstretched | 5 | −12 | −2.2 | 0.4 |
| | | | | | | casting | | | | | |
| Example 80 | ZEONOR | UMM1001 | 1000 | 2.5 | 10 | fusion | 10 | 50 | 10 | −5.0 | 0.4 |
| | | | | | | casting | | | | | |
| Example 81 | ZEONOR | PSt | 800 | 0.64 | 10 | fusion | unstretched | 2 | −18 | −2.8 | 0.5 |
| | | | | | | casting | | | | | |
| Example 82 | ZEONOR | PSt | 800 | 0.64 | 10 | fusion | 10 | 48 | 15 | −4.5 | 0.5 |
| | | | | | | casting | | | | | |
| Comparative | Appear | none | — | — | — | solution | unstretched | 32 | 285 | — | 0.2 |
| Example 6 | 3000 | | | | | casting | | | | | |
| Example 83 | Appear | UMM1001 | 1000 | 0.95 | 10 | solution | unstretched | 10 | 201 | −8.4 | 0.4 |
| | 3000 | | | | | casting | | | | | |
| Example 84 | Appear | UMM1001 | 1000 | 0.95 | 10 | solution | 10 | 72 | 230 | −7.0 | 0.3 |
| | 3000 | | | | | casting | | | | | |
| Example 85 | Appear | PSt | 800 | 0.91 | 10 | solution | unstretched | 18 | 195 | −9.0 | 0.2 |
| | 3000 | | | | | casting | | | | | |
| Example 86 | Appear | PSt | 800 | 0.91 | 10 | solution | 10 | 63 | 220 | −8.0 | 0.2 |
| | 3000 | | | | | casting | | | | | |

| | | | | | | | | |
|---|---|---|---|---|---|---|---|---|
| Comparative | P-1 | PVP | 10000 | 8.5 | 10 | solution | 20 | immeasurable due to whitening |
| Example 7 | | | | | | casting | | |

TABLE 2

| | | | Weight | | Added | | | | | | | |
|---|---|---|---|---|---|---|---|---|---|---|---|---|
| | Cyclic | | Average | \|σ(A) − | Amount A % | Film- | Film | | | | Rth(A) − | |
| | Polyolefin | | Molecular | σ(P)\| | vs. Cyclic | Forming | Thickness | | Re | Rth | Rth(0)/A | |
| | Resin | Additive | Weight | (MPa)^{1/2} | Olefin | Method | μm | Stretch ratio % | nm | nm | nm/% | Haze |
| Comparative | P-1 | none | — | — | — | solution | 198 | unstretched | 30 | 612 | — | 0.5 |
| Example 8 | | | | | | casting | | | | | | |
| Comparative | P-1 | none | — | — | — | solution | 78 | unstretched | 18 | 272 | — | 0.3 |
| Example 9 | | | | | | casting | | | | | | |
| Comparative | P-1 | none | — | — | — | solution | 60 | unstretched | 15 | 224 | — | 0.4 |
| Example 10 | | | | | | casting | | | | | | |
| Comparative | P-1 | none | — | — | — | solution | 55 | unstretched | 18 | 205 | — | 0.2 |
| Example 11 | | | | | | casting | | | | | | |
| Comparative | P-1 | none | — | — | — | solution | 42 | unstretched | 1 | 152 | — | 0.3 |
| Example 12 | | | | | | casting | | | | | | |
| Comparative | P-1 | none | — | — | — | solution | 35 | unstretched | 6 | 127 | — | 0.4 |
| Example 13 | | | | | | casting | | | | | | |
| Comparative | P-1 | none | — | — | — | solution | 25 | unstretched | 12 | 90 | — | 0.3 |
| Example 14 | | | | | | casting | | | | | | |
| Comparative | P-1 | none | — | — | — | solution | 25 | 10 | 42 | 102 | — | 0.6 |
| Example 15 | | | | | | casting | | | | | | |
| Example 87 | P-1 | UMM1001 | 1000 | 0.95 | 10 | solution | 194 | unstretched | 32 | 430 | 0.0 | 0.4 |
| | | | | | | casting | | | | | | |
| Example 88 | P-1 | UMM1001 | 1000 | 0.95 | 10 | solution | 76 | unstretched | 12 | 187 | 0.0 | 0.1 |
| | | | | | | casting | | | | | | |
| Example 89 | P-1 | UMM1001 | 1000 | 0.95 | 10 | solution | 59 | unstretched | 4 | 153 | 0.0 | 0.3 |
| | | | | | | casting | | | | | | |
| Example 90 | P-1 | UMM1001 | 1000 | 0.95 | 10 | solution | 52 | unstretched | 5 | 144 | 0.0 | 0.2 |
| | | | | | | casting | | | | | | |
| Example 91 | P-1 | UMM1001 | 1000 | 0.95 | 10 | solution | 41 | unstretched | 8 | 122 | 0.0 | 0.3 |
| | | | | | | casting | | | | | | |
| Example 92 | P-1 | UMM1001 | 1000 | 0.95 | 10 | solution | 34 | unstretched | 17 | 97 | 0.0 | 0.2 |
| | | | | | | casting | | | | | | |
| Example 93 | P-1 | UMM1001 | 1000 | 0.95 | 10 | solution | 23 | unstretched | 3 | 71 | 0.0 | 0.2 |
| | | | | | | casting | | | | | | |
| Example 94 | P-1 | UMM1001 | 1000 | 0.95 | 10 | solution | 23 | 10 | 40 | 80 | 0.0 | 0.2 |
| | | | | | | casting | | | | | | |

By the implementation of the present invention, there can be provided a cyclic polyolefin transparent optical film ensuring that the intended Rth(λ) and Re(λ) can be independently and simultaneously controlled, these optical properties can be accurately controlled, the performance in terms of moisture absorption or permeation is excellent, the change in optical properties due to temperature or humidity change is small, the handling property is excellent and optical unevenness does not occur.

The entire disclosure of each and every foreign patent application from which the benefit of foreign priority has been claimed in the present application is incorporated herein by reference, as if fully set forth.

What is claimed is:

1. A cyclic polyolefin film comprising:
a cyclic polyolefin; and
a compound having a structure represented by the following formula (I) or (II): 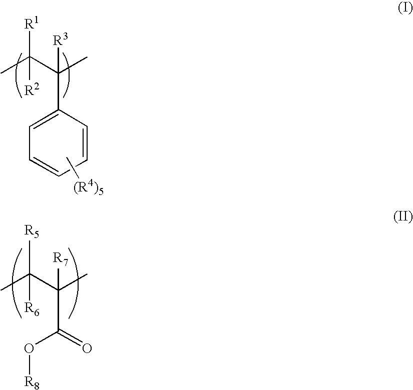
wherein
R¹ to R⁸ each independently represents a hydrogen atom; a halogen atom; a substituted or unsubstituted hydrocarbon group that has a carbon number of 1 to 30 and that may have a linking group containing an oxygen atom, a sulfur atom, a nitrogen atom or a silicon atom; or a polar group, and
R⁴s may be all the same atom or group, may be individually different atoms or groups or may combine with each other to form a carbon ring or a hetero ring, in which the carbon ring and the hetero ring may be in a monocyclic structure or may form a polycyclic structure through condensation by another ring.

2. The cyclic polyolefin film according to claim 1, which satisfies the following mathematical formula (1):

|σ(A)−σ(P)|<4 Mathematical formula (1):
wherein

|σ(A)−σ(P)| is the absolute value of σ(A)−σ(P),
σ(A) is a solubility parameter (SP value) (unit: MPa^{1/2}) of the compound having a structure represented by formula (I) or (II), and
σ(P) is the solubility parameter (SP value) (unit: MPa^{1/2}) of the cyclic polyolefin.

3. The cyclic polyolefin film according to claim 1, which satisfies the following mathematical formulae (2) and (3):
Rth(A)−Rth(0)≦−10 Mathematical formula (2):
(Rth(A)−Rth(0))/A≦−1.0 Mathematical formula (3):
wherein,
Rth(A) represents Rth (unit: nm) as converted to film thickness of 80 μm, of the film containing the compound having a structure represented by formula (I) or (II) in an amount of A % based on the mass of said cyclic polyolefin,
Rth(0) represents Rth (unit: nm) as converted to film thickness of 80 μm, of the film not containing the compound having a structure represented by formula (I) or (II), and
A represents a mass (unit: %) of the compound having a structure represented by formula (I) or (II) based on the mass of said cyclic polyolefin.

4. The cyclic polyolefin film according to claim 1, wherein
the compound having a structure represented by formula (I) or (II) has a weight average molecular weight of from 500 to 300,000.

5. The cyclic polyolefin film according to claim 1, wherein
the compound having a structure represented by formula (I) or (II) is contained in an amount of 0.1 to 40 mass % based on the cyclic polyolefin.

6. The cyclic polyolefin film according to claim 1, which is a stretched cyclic polyolefin.

7. The cyclic polyolefin film according to claim 1, which has a thickness of from 20 to 200 μm.

8. A polarizing plate comprising:
a polarizer; and
a pair of protective films, between which the polarizer is sandwiched,
wherein at least one of the protective films is the cyclic polyolefin film according to claim 1.

9. A liquid crystal display device comprising
a liquid crystal cell; and
a pair of polarizing plates, between which the liquid crystal display is sandwiched,
wherein at least one of the polarizing plates is the polarizing plate according to claim 8.
